(19) United States
(12) Patent Application Publication
(10) Pub. No.: US 2014/0321376 A1
(43) Pub. Date: Oct. 30, 2014

(54) LTE-WLAN CENTRALIZED DOWNLINK SCHEDULER

(71) Applicant: QUALCOMM Incorporated, San Diego, CA (US)

(72) Inventors: Jelena Damnjanovic, Del Mar, CA (US); Vikas Jain, San Diego, CA (US); Deepak Wadhwa, San Diego, CA (US)

(73) Assignee: QUALCOMM Incorporated, San Diego, CA (US)

(21) Appl. No.: 14/263,735

(22) Filed: Apr. 28, 2014

Related U.S. Application Data
(60) Provisional application No. 61/817,165, filed on Apr. 29, 2013.

(51) Int. Cl. H04W 72/04

(52) U.S. Cl. CPC H04W 72/042
USPC 370/329

(57) ABSTRACT

Techniques for managing downlink transmissions from a base station to multiple UEs over aggregated LTE and WLAN links are provided. The base station may jointly assign resources for transmitting downlink data during a scheduling instance. The resource assignment may include a prioritization based on channel conditions and system throughput when the links are considered jointly. In accordance with the joint resource assignment, the base station may build packets for the downlink transmission at an aggregating layer which, for example, may be coupled to media access control (MAC) elements associated with the respective links. The base station may then transmit the packets to at least a subset of the UEs based on the joint resource assignment.

### CROSS REFERENCES

The present Application for Patent claims priority to U.S. Provisional Patent Application No. 61/817,165 by Damnjanovic et al., entitled “LTE-WLAN Centralized Downlink Scheduler” filed Apr. 29, 2013, assigned to the assignee hereof, and expressly incorporated by reference herein.

### BACKGROUND

The following relates generally to wireless communication, and more specifically to the concurrent use of different technologies. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. In some wireless networks, a user equipment (UE) may be capable of supporting multiple wireless technologies concurrently. For example, a UE may simultaneously transmit data over a wireless local area network (WLAN) link and a Long Term Evolution (LTE) link. In traditional systems, uplink and downlink resources for these systems are controlled separately.

### SUMMARY

The described features generally relate to one or more improved systems, methods, and/or apparatuses for managing downlink transmissions from a base station to multiple UEs over aggregated LTE and WLAN wireless links. The base station may jointly assign resources for transmitting downlink data during a scheduling instance. The resource assignment may include prioritizing based on channel conditions and system throughput when the links are considered jointly. In accordance with the joint resource assignment, the base station may build packets for the downlink transmission at an aggregating layer which, for example, may be coupled to media access control (MAC) layer elements associated with the respective links. The base station may then transmit the packets to at least a subset of the UEs based on the joint resource assignment. The utilization of the LTE and WLAN resources in this way may be more balanced, leading to an overall increase in data throughput and an improvement in user experience.

According to a first illustrative configuration, a method of managing downlink transmissions at a base station may include determining a plurality of user equipments (UEs) to which data may be transmitted on one or more Long-Term Evolution (LTE) link and a wireless local area network (WLAN) link during a transmission interval and determining data for the downlink (DL) transmission. The method may further include jointly assigning resources for transmitting the data during the transmission interval when the UEs are served on the one or more of the LTE link and the WLAN link. According to an example, the joint assignment of the resources may include prioritizing portions of the data for the DL transmission on the LTE and the WLAN links on a per-link basis and requesting packets for the DL transmission based on the jointly assigned resources from an aggregating layer of the base station. The method may also include transmitting packets received from the aggregating layer to at least a subset of the UEs during transmission interval.

In certain examples, the joint assignment of resource on a WLAN link may be based at least in part on a fill level of one or more WLAN transmit buffers prior to the transmission interval for which the data is scheduled or based at least in part on a channel quality of the WLAN link. The joint assignment of resources may also be based at least in part on a transmission delay associated with the WLAN link and a transmission delay associated with the LTE link.

According to some examples, the method may further include determining channel quality of the WLAN link according to a WLAN interface data link rate or a WLAN interface error rate. Additionally, in certain examples each of the plurality of UEs may be associated with at least one LTE logical channel, and the base station may determine a priority of each LTE logical channel implemented by each of the plurality of UEs. The base station may further determine an amount of downlink data to add to one or more WLAN transmit buffers for each of the LTE logical channels implemented by each of the UEs in an order defined by the determined priority. The one or more WLAN transmit buffers may be associated with different Quality of Service (QoS) levels.

In certain examples, a WLAN priority for each LTE logical channel implemented by each of the plurality of UEs may be determined, and a WLAN priority list including an ordering of the LTE logical channels implemented by each of the plurality of UEs may be generated according to a WLAN priority assigned to each LTE logical channel.

In certain examples, the base station may determine that a scheduling instance for the WLAN link coincides with a scheduling instance for the LTE link, determine an LTE priority for each LTE logical channel implemented by each of the plurality of UEs, generate an LTE priority list comprising an ordering of the LTE logical channels implemented by each of the plurality of UEs according to an LTE priority assigned to each LTE logical channel, combine the LTE priority list with the WLAN priority list; and assign data for DL transmission between the LTE link and the WLAN link in an order based on the combination of the LTE priority list with the WLAN priority list.

In certain examples, a tentative amount of downlink data to place in the one or more WLAN transmit buffers associated with that LTE logical channel may be determined according to the order defined by the determined priority. The tentative amount of data may be based at least in part on a maximum estimated buffer size for the one or more WLAN transmit buffers associated with that LTE logical channel and an amount of available downlink data for that LTE logical channel.

The maximum estimated buffer size for the one or more WLAN transmit buffers associated with that LTE logical channel may be determined based at least in part on a remaining amount of time within the transmission interval and an estimated data transmit rate from the one or more WLAN transmit buffers to the UE implementing the LTE logical channel.

In certain examples, a determination may be made whether to add the tentative amount of the downlink data from that LTE logical channel to the one or more WLAN transmit buffers associated with that LTE logical channel. The determination may be based on a prioritization between the LTE network and the WLAN for that LTE logical channel and the UE implementing that LTE logical channel during the transmission interval.

In certain examples, the base station may determine the prioritization between the WLAN network and the LTE network for that LTE logical channel during the transmission interval based on a difference in a total estimated delay of transmitting a total amount of available data for the one or more WLAN transmit buffers associated with that LTE logical channel over the LTE network and a total estimated delay of transmitting the total amount of available data for the one or more WLAN transmit buffers associated with that LTE logical channel according to the determined tentative amount.

In certain examples, the base station may determine, in response to a determination to add the tentative amount of downlink data to the one or more WLAN transmit buffers associated with that LTE logical channel, whether downlink LTE resources are currently scheduled for the UE implementing that LTE logical channel during the transmission interval. Based on the determination that downlink LTE resources are currently scheduled for the UE, the base station may update tentative LTE downlink resource assignments.

In certain examples, the base station may add a determined amount of the downlink data to one or more WLAN transmit buffers for each of the LTE logical channels implemented by each of the UEs and determine that an estimated amount of resources associated with a current amount of data in the one or more WLAN transmit buffers is less than a threshold following the adding of the first portion of the downlink data to the one or more WLAN transmit buffers. The base station may then determine a new amount of downlink data to add to the one or more WLAN transmit buffer for each of the LTE logical channels implemented by each of the UEs in an order defined by the determined priority.

According to a second illustrative configuration, a base station may include a first radio configured to communicate over an LTE link; a second radio configured to communicate over a WLAN link; and a scheduler module operative to control the first radio and the second radio and configured to determine data for the downlink (DL) transmission. The scheduler module may be further configured to jointly assign resources for transmitting the data during a transmission interval when a plurality of UEs are served by the base station on the LTE link and the WLAN link. According to an example, the joint assignment of the resources may include prioritizing portions of the data for the DL transmission on the LTE and the WLAN links on a per-link basis and requesting packets for the DL transmission based on the jointly assigned resources from an aggregating layer of the base station. The scheduler module may be further configure to send the packets generated by the aggregating layer to the first radio and the second radio for transmission on the LTE link and the WLAN link respectively.

In certain examples, the base station of the second illustrative configuration, and in particular the scheduler module, may be configured to implement one or more aspects of the functionality described above with reference to the method of the first illustrative configuration.

According to a third illustrative configuration, a base station apparatus for managing downlink transmissions may include means for determining by a base station, a plurality of user equipments (UEs) for downlink data transmission on one or more of LTE link and a WLAN link during a transmission interval; means for determining data for the downlink (DL) transmission; means for jointly assigning resources for transmitting the data when the UEs are served on the one or more of the LTE link and the WLAN link. In certain examples, the means for jointly assigning resources may include means for prioritizing portions of the data for the DL transmission on the respective LTE and the WLAN links on a per-link basis and means for requesting packets for the DL transmission based on the jointly assigned resources from an aggregating layer of the base station. The base station apparatus may also include means for transmitting packets received from the aggregating layer to at least a subset of the UEs during transmission interval.

In certain examples, the base station of the third illustrative configuration, may include means for implementing one or more aspects of the functionality described above with reference to the method of the first illustrative configuration.

According to a fourth illustrative configuration, a computer program product may include a non-transitory computer readable medium having a computer-readable program code stored thereon. The computer-readable program code may include: computer-readable program code configured to cause at least one processor to determine a plurality of user equipments (UEs) for downlink data transmission on one or more of LTE link and WLAN link; computer-readable program code configured to cause the at least one processor to determine data for the downlink (DL) transmission; computer-readable program code configured to cause the at least one processor to jointly assigning resources for transmitting the data during the transmission interval when the UEs are served on the one or more of the LTE link and the WLAN link including computer-readable program code configured to cause the at least one processor to prioritize portions of the data for the DL transmission on the LTE and the WLAN links on a per-link basis, computer-readable program code configured to cause the at least one processor to request packets for the DL transmission based on the jointly assigned resources from an aggregating layer of the base station. The computer-readable program code may be further configured to cause the at least one processor to transmit packets received from the aggregating layer to at least a subset of the UEs during transmission interval.

In certain examples, the computer-readable program code may include computer-readable program code configured to cause at least one processor to implement one or more aspects of the functionality described above with reference to the method of the first illustrative configuration.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an illustrative wireless communications system;

FIG. 2 is a block diagram of an illustrative wireless communications system that includes multiple radio access technologies (RATs);

FIG. 3 shows illustrative downlink channels in a wireless communications system;

FIG. 4 is a block diagram of an exemplary wireless communications system;

FIG. 5 shows aspects of a base station according to the present disclosure;

FIGS. 6A-6C show diagrams of illustrative WLAN downlink scheduling intervals at a base station;

FIG. 7 shows aspects of WLAN buffer management in an exemplary scheduling interval;

FIG. 8 shows aspects of WLAN buffer management;

FIG. 9 is a block diagram of an illustrative base station;

FIG. 10 is a block diagram of an illustrative base station;

FIG. 11 is a block diagram of an exemplary wireless communications system;

FIG. 12 is a flowchart showing operations performed at a base station;

FIG. 13 shows an exemplary method of joint resource assignment on LTE and WLAN links;

FIG. 14 shows further details of the method depicted in FIG. 13.

### DETAILED DESCRIPTION

The present description discloses methods, systems, apparatuses, and computer program products for managing downlink transmissions from a base station that is capable of communicating with multiple user equipments (UEs) over simultaneous LTE and WLAN wireless links. The disclosed methods, systems, apparatuses, and computer programs provide for jointly assigning resources for downlink transmission from an aggregating layer of the base station during a transmission interval. In the case of radio link control (RLC) aggregation, data belonging to a bearer may be scheduled and transmitted on the LTE wireless link, the WLAN wireless link, or both links at the same time. The base station may strategically schedule downlink communications over the WLAN wireless link using an information available to it on channel conditions, buffers, and/or presence of other UEs, etc., to increase an overall data throughput and improve user experience throughout a wireless communication system.

According to the principles of the present description, the base station may dynamically schedule downlink transmissions over one or more LTE and WLAN wireless links. In the case of the WLAN wireless link, the base station may schedule downlink transmission on a periodic and/or event-based basis. In the case of periodic scheduling, at least some of the scheduling intervals for the downlink WLAN transmissions may align with LTE scheduling intervals. Using aggregation, the LTE and WLAN wireless links may be integrated such that the base station may selectively utilize the LTE and WLAN wireless links to transmit downlink data. Specifically, the base station may, for each of a number of UEs at each scheduling interval, determine an amount of data to be transmitted over the WLAN wireless link and over downlink LTE resources. The base station may determine the amount to be transmitted over the WLAN link based at least in part on a joint state of the LTE wireless link and the WLAN link.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

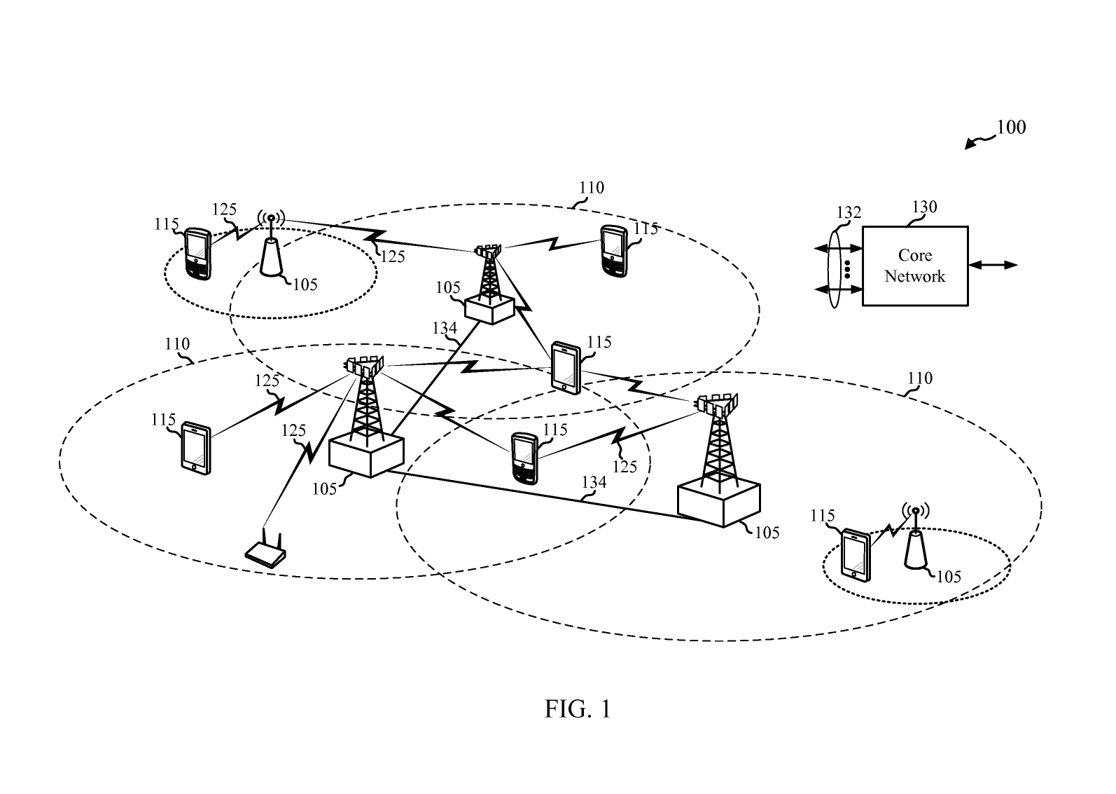

Referring first to FIG. 1, a diagram illustrates an example of a wireless communications system 100. The wireless communications system 100 may include base stations 105, communication devices 115, and a core network 130. The base stations 105 may support a number of cells for communicating with the communication device 115 and may be coupled to a core network 130. Base stations 105 may communicate control information and/or user data with the core network 130 through backhaul links 132. In some examples, the base stations 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the communication devices 115 via one or more base station antennas. Each of the base station 105 sites may provide communication coverage for a respective geographic area 110. In some examples, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The geographic coverage area 110 for a base station may be divided into sectors making up only a portion of the coverage area (not shown). The wireless communications system 100 may include base stations 105 of different types (e.g., macro, micro, and/or pico base stations). There may be overlapping coverage areas for different technologies.

In examples, the wireless communications system 100 may be an LTE/LTE-A network. In LTE/LTE-A networks, the terms evolved Node B (eNB) and user equipment (UE) may be generally used to describe base stations 105 and communications devices 115, respectively. The wireless communications system 100 may be a Heterogeneous LTE/LTE-A network in which different types of eNBs provide coverage for various geographical regions. For example, each eNB 105 may operate as a macro cell, a pico cell, a femto cell, and/or other types of cell or power classifications. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and may provide restricted access to UEs having an association with the femto cell (e.g., UEs in a closed subscriber group (CSG), UEs for users in the home, and the like), open access, or hybrid access. An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the eNBs 105 via a backhaul 132 (e.g., S1, etc.). The eNBs 105 may also communicate with one another, e.g., directly or indirectly via backhaul links 134 (e.g., X2 interface, etc.) and/or via backhaul links 132 (e.g., through core network 130). The wireless communications network 100 may support synchronous or asynchronous operation. For synchronous operation, the eNBs 105 may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a communications device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a handheld device, a tablet computer, a laptop computer, a cordless phone, a wireless local loop (WLL) station, or the like. A UE 115 may be able to communicate with base stations such as macro eNBs, pico eNBs, femto eNBs, relays, and the like which form part of the wireless communications system 100.

The communication links 125 shown in the wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions.

In certain examples, heterogeneous radio access technologies (RAT) may be available within the wireless communications system 100 such that the UEs 115 may access the core network 130 over one or more different RATs. For example, the base stations 105 of the wireless communications system 100 may include both LTE eNBs and WLAN access points (APs). In certain examples, one or more LTE eNBs may be collocated with one or more WLAN APs. For instance, a multi-RAT base station 105 may implement both an eNB and a WLAN AP to communicate with a UE 115 over separate LTE and WLAN networks. Certain base stations 105 may support LTE-WLAN carrier (or link) aggregation that allows the base stations 105 to communicate simultaneously with one or more UEs 115 over both the LTE and WLAN networks. Aggregation may be performed at a particular protocol layer of the base station. As discussed herein, the single layer of the base station, also referred to as an aggregating layer, may be responsible for aggregating downlink data for the various links so that the base station supporting LTE-WLAN link aggregation may selectively utilize one of the RATs to transmit packets and may be coupled, for example, with media access control (MAC) elements of the respective links. As will be described in more detail with respect to the following Figures, a base station 105 supporting the LTE-WLAN link aggregation may be capable of scheduling data belonging to an LTE bearer for transmission over WLAN network and LTE network either periodically or aperiodically. For example, packets related to an LTE bearer may be scheduled for transmission over WLAN wireless network in addition to or instead of LTE wireless network.

According to one example, scheduling of data for downlink transmission at a base station 105 supporting both LTE and WLAN RATs may be performed dynamically. For instance, at each of a number of scheduling instances for the WLAN wireless links, some of which may coincide with scheduling instances for the LTE wireless links, the base station 105 may form separate priority lists for LTE and WLAN networks. The base station 105 may assign LTE resources and tentatively determine an amount of data to place into one or more WLAN transmit buffers according to an order defined by the priority lists. In some examples, the base station 105 may determine whether to use LTE network or WLAN network to transmit the tentative amount of data according to a prioritization between LTE and WLAN based at least in part on the joint state of the LTE network and the WLAN network.

For example, the state of the LTE network may include an estimated serving data rate of the base station 105 over the LTE network, as determined by one or more of: channel quality for the LTE network, a current modulation scheme used by the base station 105 to transmit downlink data over the LTE network, a current coding scheme by the base station 105 used for downlink data, network loading or congestion associated with the LTE network, and/or a transmission power associated with downlink data for the LTE network. Additionally or alternatively, the state of the LTE network may also include, for example, whether or not downlink resources are currently scheduled for a particular UE and/or corresponding LTE logical channel over the LTE. The state of the LTE network may further include, for example, whether a scheduling instance for the LTE network coincides with a current scheduling instance for the WLAN network. The state of the WLAN network may include: data rate associated with WLAN interface and/or error rates. The joint state may be based on the number of different factors associated with the state of the LTE and WLAN networks as discussed above and may additionally include, for example, an average data rate for combined links.

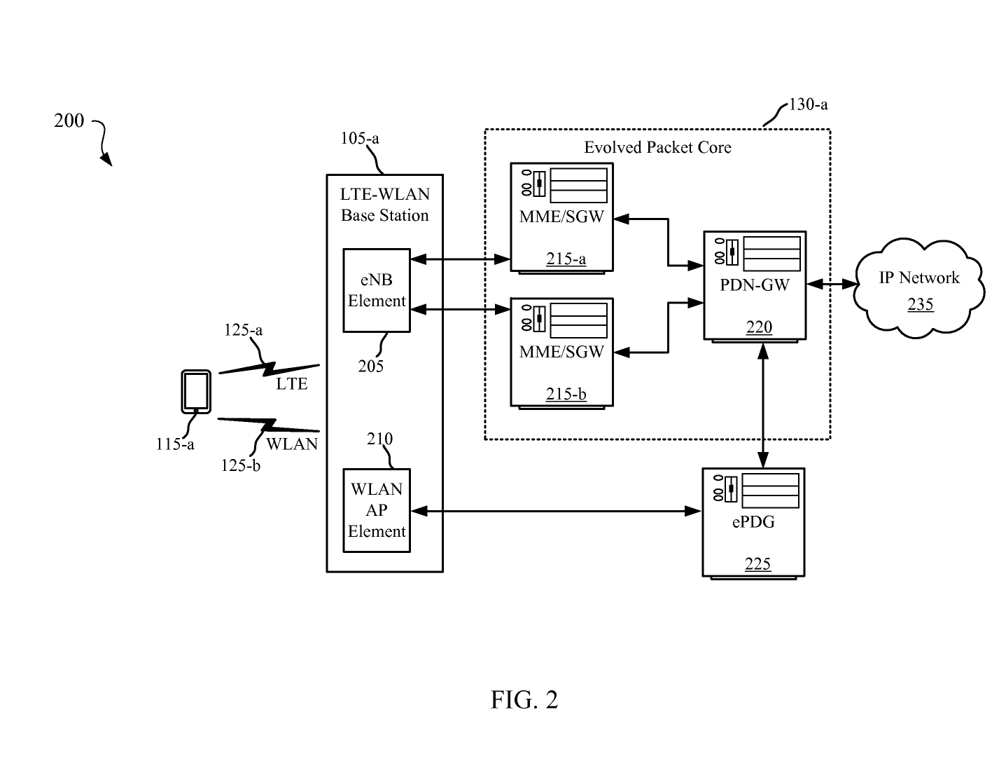

Referring now to FIG. 2, a diagram of a wireless communications system 200 is shown. The example wireless communications system 200 may include a UE 115-a, an LTE-WLAN base station 105-a, an evolved packet core (EPC) 130-a, an evolved packet data gateway (ePDG) 225, and an IP network 235. The LTE-WLAN base station 105-a may combine and connect the functionality of both an LTE eNB and a WLAN AP. Thus, the LTE-WLAN base station 105-a may include an eNB element 205 and a WLAN AP element 210.

The eNB element 205 and WLAN AP element 210 may be capable of providing the UE 115-a with access to the evolved packet core 130-a using different RATs. Specifically, the eNB element 205 of the LTE-WLAN base station 105-a may provide access to the evolved packet core 130-a over LTE access technology, and the WLAN AP element 210 of the LTE-WLAN base station 105-a may provide access to the evolved packet core 130-a over WLAN access technology defined by the 802.11 standard from the Institute of Electrical and Electronic Engineers (IEEE).

The evolved packet core 130-a may include a number of mobility management entity/serving gateway (MME/SGW) devices 215 and a number of packet data network (PDN) gateways (PDN-GWs) 220. Each of the MME/SGW devices 215 may implement both a mobile management entity (MME) and a serving gateway (SGW), as defined by the Evolved Packet System (EPS) architecture standardized by the 3GPP organization. Alternatively, the MMEs and SGWs may be implemented as separate devices. The MME may be the control node that processes the signaling between the UE 115-a and the EPC 130-a. Generally, the MME may provide bearer and connection management. The MME may, therefore, be responsible for idle mode UE tracking and paging, bearer activation and deactivation, and SGW selection for the UE 115-a. The MME may additionally authenticate the UE 115-a and implement Non-Access Stratum (NAS) signaling with the UE 115-a. All user IP packets may be transferred through the Serving Gateways, which may be connected to the PDN-GWs 220. The SGW may reside in the user plane and act as a mobility anchor for inter-eNB handovers and handovers between different access technologies.

The PDN-GWs 220 may provide connectivity to one or more external packet data networks (PDNs), such as IP network 235. The PDN-GWs 220 may provide UE IP address allocation as well as other functions. The PDN(s) may include the Internet, an Intranet, an IP Multimedia Subsystem (IMS), a Packet-Switched (PS) Streaming Service (PSS), and/or other types of PDNs.

The eNB element 205 may access the evolved packet core 130-a directly by communicating with the MME/SGWs. The WLAN AP element 210 may access the evolved packet core 130-a through the evolved packet data gateway (ePDG) 225, which may be configured to secure data transmission with UEs 115-a connected over non-3GPP access. Thus, the ePDG may act as a termination node of IPsec tunnels associated with the UE 115-a.

As shown in FIG. 2, the UE 115-a may access the EPC 130-a and, by extension, the IP network 235 through either an LTE communication link 125-a with eNB element 205 or a WLAN communication link 125-b with the WLAN access point element 210. In certain examples, the LTE-WLAN base station 105-a may aggregate the LTE communication link 125-a with the WLAN wireless communication 125-b such that the WLAN communication link 125-b may carry packets related to LTE bearers. The LTE-WLAN base station 105-a may perform downlink WLAN scheduling on a periodic and/or aperiodic basis to increase the overall downlink throughput between the EPC 130-a and the communication device 115-a. This scheduling may be based at least in part on the state (e.g., congestion, rate, modulation type, coding scheme, channel quality, transmit power, scheduling, etc.) of the LTE wireless link 125-a in comparison to the state of the WLAN wireless link 125-b. According to one example, the scheduling may be based on the joint state of the LTE and the WLAN networks. The LTE-WLAN base station 105-a may schedule the transmission of packets related to one or more LTE bearers over the WLAN wireless link 125-b to increase the speed or efficiency of downlink communications between the EPC 130-a and the UE 115-a.

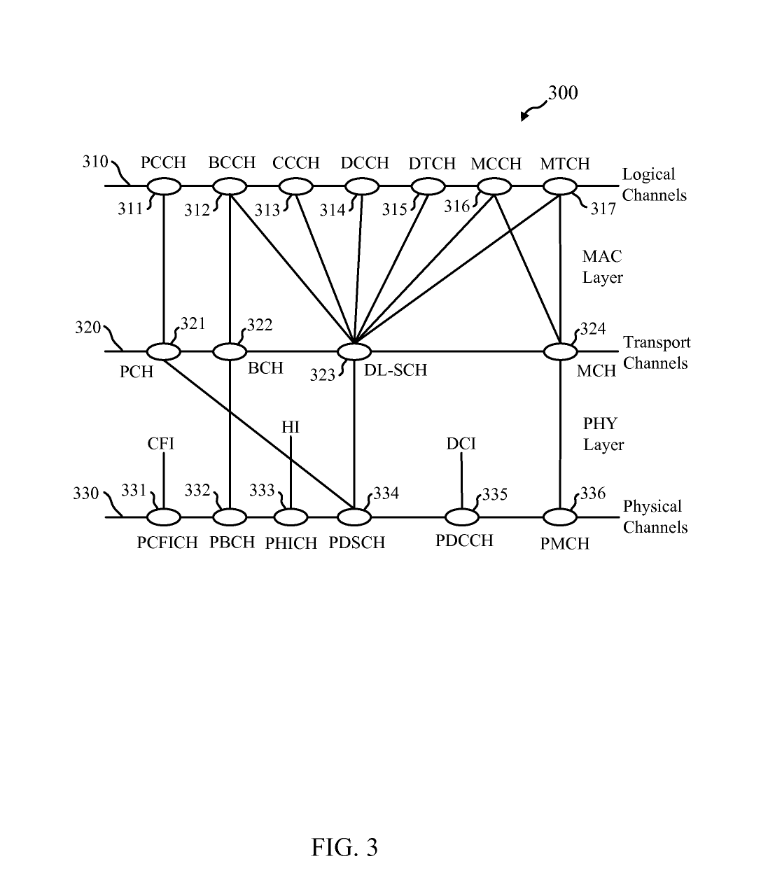

FIG. 3 illustrates a channelization hierarchy 300 for downlink communications with a communication device 115 that may be used by the wireless communications systems 100 and/or 200 in accordance with various examples. The channelization hierarchy 300 may illustrate, for example, channel mapping between LTE logical channels 310, downlink transport channels 320, and downlink physical channels 330 of an LTE/A network. LTE logical channels 310 may be classified into Control Channels and Traffic Channels. Logical control channels may include a paging control channel (PCCH) 311, which is the downlink channel that transfers paging information, a broadcast control channel (BCCH) 312, which is the downlink channel for broadcasting system control information, a multicast control channel (MCCH) 316, which is a point-to-multipoint downlink channel used for transmitting multimedia broadcast and multicast service (MBMS) scheduling and control information for one or several multicast traffic channels (MTCHs) 317.

Generally, after establishing radio resource control (RRC) connection, MCCH 116 is only used by the UEs that receive MBMS. Dedicated control channel (DCCH) 314 is another logical control channel that is a point-to-point bi-directional channel transmitting dedicated control information, such as user-specific control information used by the user equipment having an RRC connection. Common control channel (CCCH) 313 is also a logical control channel that may be used for random access information. Logical traffic channels may include a dedicated traffic channel (DTCH) 315, which is a point-to-point bi-directional channel dedicated to one user equipment for the transfer of user information and a MTCH 317, which may be used for point-to-multipoint downlink transmission of traffic data.

The communication networks that accommodate some of the various embodiments may additionally include downlink transport channels 320. The DL transport channels 320 may include a broadcast channel (BCH) 322, a downlink shared data channel (DL-SCH) 323, a multicast channel (MCH) 324 and a Paging Channel (PCH) 321.

The downlink physical channels 330 may include a physical broadcast channel (PBCH) 332, a physical control format indicator channel (PCFICH) 331, a physical downlink control channel (PDCCH) 335, a physical hybrid ARQ indicator channel (PHICH) 333, a physical downlink shared channel (PDSCH) 334 and a physical multicast channel (PMCH) 336.

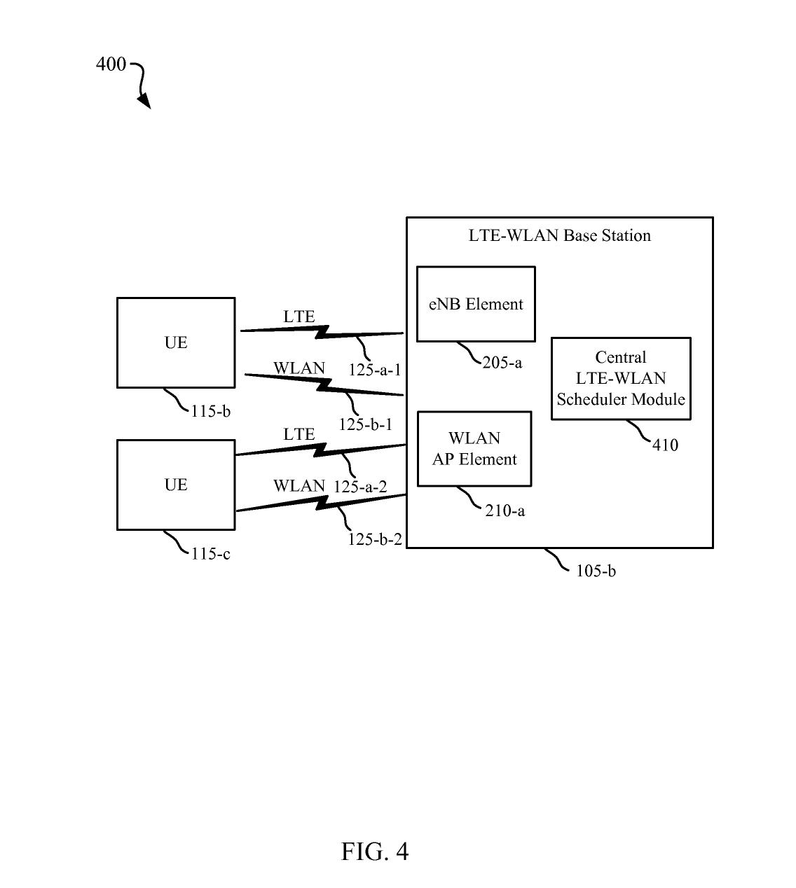

FIG. 4 is a block diagram of another wireless communications system 400 that includes multiple UEs 115 communicatively coupled with a network node, such as for example, an LTE-WLAN base station 105-b. According to one example, the LTE-WLAN base station 105-b may include collocated eNB and WLAN AP elements 205-a, 210-a that respectively implement LTE eNB and WLAN AP functionality in a same network node. In certain configurations, the LTE-WLAN base station 105-b may implement a protocol stack in which the eNB element 205-a has an LTE-specific PHY layer coupled to an LTE-specific MAC layer, and the WLAN AP element 210-a has a WLAN-specific PHY layer coupled to a WLAN-specific MAC layer. The separate LTE- and WLAN-specific MAC layers may be coupled to a common LTE-WLAN layer (e.g. RLC layer) for which a central LTE-WLAN scheduler module 410 performs joint prioritization and classification functions. The UEs 115 may communicate with the eNB element 205-a of the LTE-WLAN base station 105-b over LTE communication links 125-a and with the WLAN AP element 210-a of the LTE-WLAN base station 105-b over WLAN communication links 125-b. The system 400 of FIG. 4 may be an example of one or more of the systems and networks 100, 200 described above with reference to the previous Figures.

The central LTE-WLAN scheduler module 410 may determine whether to transmit downlink packets related to LTE logical channels and bearers from a common (i.e. aggregating) layer of the base station over the LTE communication links 125-a and/or the WLAN communication links 125-b. As discussed previously, the central LTE-WLAN scheduler module 410 may jointly schedule transmission of packets for the LTE bearers over both the LTE communication links 125-a and the WLAN communication links 125-b at the same time.

The central LTE-WLAN scheduler module 410 may perform downlink scheduling for the UEs 115 at each of a plurality of scheduling intervals. The scheduling intervals may be periodic, aperiodic, or both. In particular, the central LTE-WLAN scheduler module 410 may form a priority list for each downlink LTE logical channel of the UEs to be scheduled at each scheduling interval. For example, priority lists may include an ordering based on the UEs to be scheduled and a quality of service (QoS) associated with the respective LTE logical channels of the UEs to be scheduled. In examples where the scheduling interval for LTE coincides with the scheduling interval for WLAN, separate priority lists may be formed for LTE and WLAN, and the separate lists may be combined into a single priority list.

According to the priority list, the central LTE-WLAN scheduler module 410 may determine a tentative amount of data to place into a WLAN transmit buffer for each combination of an LTE logical channel and UE on the priority list, and then determine whether to actually place the tentative amount into the WLAN transmit buffer according to a prioritization between WLAN and LTE determined for that LTE logical channel and UE combination. The prioritization may be based at least in part on a state of the LTE communication link 125-a and/or a state of the WLAN communication link 125-b associated with that LTE logical channel and UE.

The provision of central LTE-WLAN scheduler module 410 at the LTE-WLAN base station 105-b may allow for the use of both LTE and WLAN communication links 125 for downlink transmissions of LTE bearers to the UEs. According to one example, bearer data may be converted into RLC service data units (SDUs) at the RLC layer, and the RLC SDUs may be multiplexed into RLC protocol data units (PDUs) for delivery to the LTE or WLAN MAC layer based on available transmission opportunities at the two MAC layers and the scheduling decisions of the central LTE-WLAN scheduler module 410. The LTE-WLAN base station 105-b may have information about channel conditions, buffers, and the presence of other UEs on one or both of the LTE and WLAN access networks. Therefore, the LTE-WLAN base station 105-b may be capable of optimizing downlink transmissions such that overall system throughput and fairness are maximized.

The increments of data pushed into the WLAN transmit buffers of the LTE-WLAN base station 105-b may be sufficiently small to allow for quick adjustments to the changing conditions of the communication links 125. For example, as one of the communication links 125 improves in channel quality or throughput, more data may be pushed through that communication link 125 (e.g., by granting more downlink resources at the base station 105-b for one of the LTE communication links 125-a or pushing more downlink data to the WLAN transmit buffer for transmission over one of the WLAN communication links 125-b). Thus, the utilization of each communication link 125 may be based on the relative quality of that communication link 125. By optimizing the utilization of each communication link 125 based on the quality of both communication links 125, the base station 105-b may obtain an increased throughput for downlink communications to the UEs. Additionally, the base station 105-b may avoid trapping data into a WLAN communication link 125-b of poor quality. For example, if one of the WLAN communication links 125-b becomes worse, the data flow into the WLAN transmit buffer(s) for that WLAN communication link 125-b of the base station may subside until conditions improve.

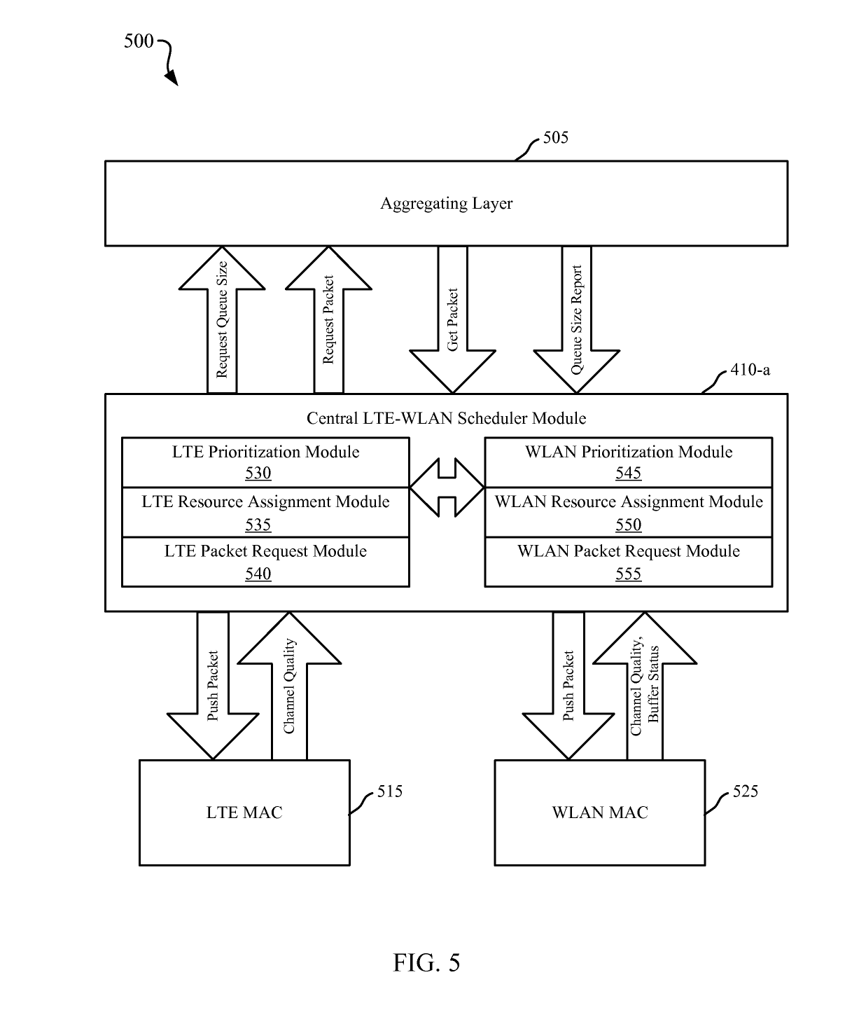

FIG. 5 is a block diagram 500 of an example interactions between a aggregating layer 505, a central LTE-WLAN scheduler module 410-a, an LTE MAC layer 515, and a WLAN MAC layer 525, as implemented by an LTE-WLAN base station, such as one or more of the LTE-WLAN base stations 105-a or 105-b described above with reference to the previous Figures. According to one example, the aggregating layer 505 may be a RLC layer that feeds protocol data units (PDUs) or packets from upper network and application layers of a protocol stack to both the LTE MAC layer 515 and the WLAN MAC layer 525 in support of multi-carrier operation. Alternatively, the aggregating layer may be a PDCP layer.

In the present example, the central LTE-WLAN scheduler module 410-a may interface with the aggregating layer 505 to request and receive queue size reports. The queue size reports may indicate an amount of downlink data ready to be transmitted from the base station to one or more UEs in communication with the base station. The data may be associated with different logical channels which, in turn, may be associated with bearers.

An LTE prioritization module 530 of the central LTE-WLAN scheduler module 410-a may determine a priority of LTE transmissions for the UEs according to an LTE-specific proportional fairness calculation. Similarly, a WLAN prioritization module 545 may determine a priority of the WLAN transmissions for the UEs according to an LTE-specific proportional fairness calculation. According to one example, prioritization may include giving strict priority to a logical channel with higher scheduling priority level and using a proportional fair algorithm for the logical channels with the same scheduling priority level.

An LTE resource assignment module 535 and a WLAN resource assignment module 550 of the central LTE-WLAN scheduler module 410-a may select and assign LTE and WLAN resources for different portions of downlink data to be transmitted over the LTE logical channels based on the priority lists generated by the LTE and WLAN prioritization modules, 530 and 545, respectively. An LTE packet request module 540 and a WLAN packet request module 555 of the central LTE-WLAN scheduler module 410-a may selectively request downlink packets from the aggregating layer 505. In one implementation, request for downlink packets may trigger packet building at the aggregating layer intended for the LTE and/or WLAN transmissions. The LTE and WLAN packet request modules may then push the received downlink packets to the LTE MAC layer 515 and the WLAN MAC layer 525 respectively, based on a determined priority of the LTE logical channel and UE associated with each downlink packet and a determined priority between the LTE and WLAN wireless links for each LTE logical channel and UE. One or more of these determined priorities may be based at least in part on channel quality reports received from the LTE MAC layer 515, and channel quality and buffer status reports received from the WLAN MAC layer 525.

As discussed above, scheduling is a dynamic process with the scheduling intervals for LTE downlink transmissions occurring periodically (e.g., every 1 millisecond), and scheduling intervals for WLAN downlink transmissions occurring periodically and/or aperiodically. At least some of the time, it may be desirable to couple the LTE downlink scheduling intervals and the WLAN downlink scheduling intervals to enable joint processing. According to one example, coupling of the downlink scheduling intervals may be accomplished by postponing WLAN scheduling until an LTE scheduling time instance arrives. In some instances, the trigger based WLAN functionality, which in general is considered to be independent of the LTE timeline, may also be added to the overlapping scheduling, for example, to prevent a possibility of the buffer underflow on the WLAN link. During the periodic coupled operation, at each of a number of the overlapping periodic downlink scheduling intervals, the central LTE-WLAN scheduler module 410-a may perform a joint resource assignment in which, for each of a plurality of LTE logical channels and UEs, it is determined how much data for is to be pushed to the corresponding transmit buffer(s) of the WLAN MAC layer 525.

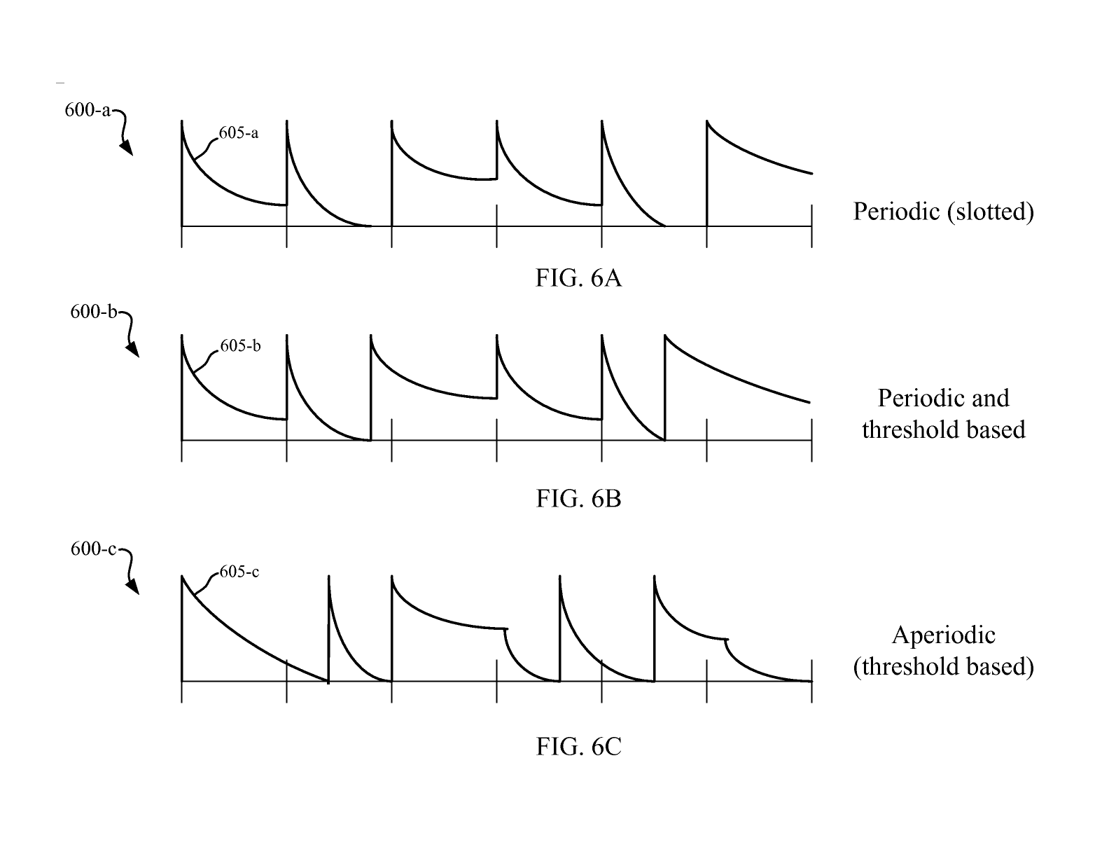

Referring now to FIGS. 6A-6C, different examples are shown of WLAN scheduling intervals that may be used by the central LTE-WLAN scheduler module 410-a of FIG. 5. In these examples, the x axes represent time, the y axes represent the content of a transmit buffer of the WLAN MAC layer 525 of FIG. 5, and plots 605 represent the content of the transmit buffer with respect to the passage of time.

In the example of FIG. 6A, WLAN downlink scheduling intervals may be periodic such that WLAN downlink scheduling may be performed upon the expiration of a set interval period, without regard to the state of the transmit buffer. In the example of FIG. 6B, the WLAN downlink scheduling intervals may be both periodic and threshold or event-based, such that WLAN downlink scheduling occurs at the expiration of each WLAN downlink period, and additionally whenever the content of the WLAN transmit buffer drops to or below a threshold. In the example of FIG. 6C, the WLAN downlink scheduling intervals may be strictly threshold or event-based, such that WLAN downlink scheduling occurs whenever the content of the WLAN transmit buffer drops to a threshold (zero, in this example).

Returning now to FIG. 5, a more detailed description of the operations of the central LTE-WLAN scheduler module 410-a of an LTE-WLAN base station, such as the base station 105-a or 105-b described above with reference to the previous Figures will now be provided. Resource assignment performed by the WLAN resource assignment module 550 of the central LTE-WLAN scheduler module 410-a may determine a tentative amount of data to put into the one or more WLAN transmit buffers of the WLAN MAC layer 525 for each LTE logical channel and each UE, according to a prioritized order, based on current channel conditions (including loading) of the WLAN communication link and the leftover WLAN transmit buffer size from the previous scheduling instance (i.e., data that was not transmitted from the WLAN transmit buffer in the previous scheduling instance). Upon determining the tentative amount of data to put into the WLAN transmit buffer(s), the central LTE-WLAN scheduler module 410-a may then determine whether to schedule any of the tentative amount of data for WLAN transmission based on the conditions of the LTE wireless link and the WLAN wireless link. In one example, the decision may be based on the joint state of the LTE and WLAN wireless links.

According to one implementation, at each scheduling interval, the central LTE-WLAN scheduler module 410-a may first perform prioritization of individual LTE logical channels for individual UEs and form one or more downlink priority lists. If the scheduling interval corresponds to an LTE scheduling window, a priority list for LTE scheduling may be determined based on an LTE priority metric by the LTE prioritization module 530. If the scheduling interval corresponds to a WLAN scheduling window, a proportional fair list for WLAN scheduling may be determined based on a WLAN priority metric by the WLAN prioritization module 545. In instances when the scheduling interval corresponds to both an LTE and a WLAN scheduling window, separate LTE and WLAN lists may be first determined for both LTE and WLAN and subsequently combined to form a single priority list ordered according to priority metric using one of a number of methods discussed below.

In certain examples, prioritization among users may be determined by computing a priority metric PM for a given UE i, LTE logical channel j, and a given RAT (i.e., LTE or WLAN) as follows:

$${PM}_{i}^{j} = \frac{{R}_{max , j}}{max ( {R}_{avg , i}^{j} , ρ ) \cdot {( 1 - \frac{min ( {D}_{i}^{j} , {D}_{max , i}^{j} - ɛ )}{{D}_{max , i}^{j}} )}^{δ}}$$

where R_{max,i}, is a requested data rate for that RAT based on the supportable modulation and coding scheme (MCS), as determined by the channel quality of that RAT for UE i, R_{avg,i}^{j} is an average rate of data served to UE i for LTE logical channel j over both RATs, D_{max,i}^{j} is a delay deadline associated with the Quality of Service (QoS) requirements of LTE logical channel j at UE i, Dᵢ^{j} is a current head of line delay deadline, δ is a scheduling metric exponent, and ε and ρ are small numbers to prevent division by zero.

As discussed above, separate priority lists may be determined for LTE and WLAN at their respective scheduling instances. The parameters used to determine PM for each RAT may be RAT-specific, with the exception of R_{avg,i}^{j}, which may represent the average data rate observed on both LTE and WLAN for that LTE logical channel and UE. The use of a common term for average data rate on both RATs may capture the overall observed service and provide fairness control at the UE level across both R_{avg,i}^{j} may be computed as follows:

R_{avg,i}^{j}(t)=(1−αⱼ)*R_{avg,i}^{j}(t−1)+αⱼ*ScheduledRate^{j}(t)

where

ScheduledRateᵢ^{j}(t)=R_{LTE,i}^{j}(t)+R_{WLAN,i}^{j}(t),

R_{LTE,i}^{j}(t) and R_{WLAN,i}^{j}(t) are the newly scheduled data rates on LTE and WLAN, respectively, and αⱼ is a filter coefficient. R_{WLAN,i}^{j}(t) may not be explicitly known at the base station 105, as the scheduling for WLAN transmission in a particular scheduling instance may be only an estimate of the possible WLAN transmission. Hence, R_{WLAN,i}^{j}(t) may be calculated at the base station 105 based on the amount of data (B_{WLAN,i}^{j}(t)) put into the WLAN buffer associated with LTE logical channel j and UE i for transmission in the corresponding scheduling window (T_{sch}) as follows:

$${R}_{WLAN , i}^{j} ( t ) = \frac{{B}_{WLAN , i}^{j} ( t )}{{T}_{data}}$$

Alternatively, the average rate may be calculated as a sum of the average rates observed across both links. In such case, the composite average rate may be determined as follows:

R_{avg,i}^{j}(t)=R_{LTEavg,i}^{j}(t)+R_{WLANavg,i}^{j}(t)

where R_{LTEavg,i}^{j} is a filtered rate on LTE and R_{WLANavg,i}^{j} is the data rate averaged over the data successfully transmitted on the WLAN link within a specified (longer) time window T, where

$${R}_{WLANavg , i}^{j} ( t ) = \frac{{B}_{WLAN , i}^{j} ( t )}{T}$$

In scheduling instances where downlink transmissions for only one of LTE or WLAN are to be scheduled, a corresponding priority list for that RAT may be formed in which each LTE logical channel of each UE may be ordered according to the priority metric PM computed for that LTE logical channel, UE, and RAT. In scheduling instances where both LTE and WLAN downlink transmissions are to be scheduled, two approaches in terms of constructing the priority list are possible. In one of the approaches, separate LTE and WLAN priority lists may be calculated, and the two priority lists may be joined to form one descending list according to priority metric. Resources may then be assigned to the different LTE logical channels of the UEs based on the order of the joined list. In the second approach, a joint priority list may alternate between entries of the LTE and WLAN lists. Thus, the joint priority list may begin with the first LTE logical channel and UE on the LTE priority list, then go to the first LTE logical channel and UE on the WLAN list, then go to the second LTE logical channel and UE on the LTE list, and so on.

Following the creation of a priority list according to one of the approaches described above, the central LTE-WLAN scheduler module 410-a may begin assigning resources to the UEs in an order defined by the priority list.

Where the scheduling instance coincides with scheduling for an LTE scheduling window, LTE downlink resources may be assigned by performing stage 1 and stage 2 scheduling in accordance with normal LTE scheduling procedures.

Stage 1 scheduling may overlap or be performed concurrent to the prioritization process described above. Stage 1 tentative scheduling may occur prior to WLAN scheduling. During stage 1 scheduling, user flow or LTE logical channel objects may be created for each user, followed by user flow selection, which may include applying heterogeneous network (HetNet) constraints, semi-persistent scheduling (SPS) constraints, and/or other constraints. The user flow priority metric may then be computed, following the retrieval of user flow queue levels from the aggregating layer 505, and physical resource block (PRB) may be allocated, although the actual physical resource block locations may not be assigned in stage 1.

Stage 2 of LTE scheduling may be interleaved with WLAN assignments if the scheduling instances for LTE and WLAN coincide. During stage 2 an actual physical resource block (PRB) assignment may be made for each LTE logical channel such that each PRB is assigned a location on a resource grid. Furthermore, during stage 2 a final scheduled octet count may be computed for each LTE logical channel flow, and in case the aggregating layer is an RLC layer, an appropriate amount of protocol data units (PDUs) may be retrieved from the RLC layer. Stage 2 may also include multiplexing and assembly functionality that may be performed for MAC PDU construction. Additionally, the MAC PDUs may also be transmitted to hardware during stage 2, and layer 2 measurements, such as for example PRB usage, may be performed.

Where the scheduling instance coincides with a WLAN scheduling window, WLAN resource assignment may be performed based on the WLAN priority list. WLAN resource assignment may involve determining an amount of data to put into one or more WLAN transmit buffers for each combination of a downlink LTE logical channel and UE. This determination may take into account WLAN data left over in the WLAN transmit buffer(s) (i.e. untransmitted data) from the previous scheduling instance, channel quality, resource availability, data availability, buffer capacity, and time interval for which the data transmission is provisioned for. In particular, the central LTE-WLAN scheduler module 410-a may determine a tentative amount of data, if any, to place into the WLAN transmit buffer for each LTE logical channel and UE, and then determine whether to use LTE or WLAN to transmit that tentative amount of data based on the current state of the LTE and WLAN wireless links for that particular UE. In this way, the central LTE-WLAN scheduler module 410-a may avoid increasing the total packet delay due to the delay of data submitted to the WLAN buffer, which is no longer eligible for LTE transmission, in certain scenarios.

To aid in the discussion of resource assignment for WLAN transmission a number of parameters will be first defined.

To begin with, R_{est,i} may be defined as an estimated current data rate of the WLAN communication link for i^{th} UE (UE i) based on channel quality, an estimated maximum data rate for a modulation and coding scheme (MCS) in use, error rate, and loading on the WLAN communication links due to other WLAN access points and downlink WLAN transmissions. In certain examples, the LTE-WLAN base station (e.g. base station 105-a or 105-b shown in previous Figures) may include multiple WLAN transmit buffers associated with different Quality of Service (QoS) parameters. Thus, Rₑₛₜ may be defined for each of the WLAN transmit buffers of the LTE-WLAN base station. In certain examples, R_{est,i} may be set to equal a maximum achievable data rate R_{max,i} for the i^{th} UE given current channel conditions and the current modulation and coding scheme. Additionally or alternatively, R_{est,i} may be set to R. It will be understood that multiple LTE logical channels may be mapped to a single WLAN transmit buffer.

B_{curr,tot} may be defined as a current size or utilization of an individual WLAN transmit buffer, taking into account all LTE logical channel mappings to that particular WLAN transmit buffer across all UEs for a given QoS. B_{max,tot} may be defined as a maximum allowable buffer size or utilization for a given WLAN transmit buffer having a given QoS across all UEs. B_{min,tot} may be defined as a minimum buffer depth threshold for a given WLAN transmit buffer—that is, a minimum allowed buffer size corresponding to a minimum transmission size. B_{max,i} may be defined as a maximum buffer threshold for the i^{th} UE, which may not be subject to an amount of available data. T_{sch} may be defined as the time period for periodic buffer management (i.e., the amount of time between scheduling intervals) and also the time period of each scheduling window (i.e., the amount of time for which downlink scheduling occurs). In certain examples, T_{sch} may be multiplied by tuning coefficient α. T_{data} may be defined as the time window for which the amount of data to put into the WLAN buffer is provisioned for. B_{WLAN,i} may be defined as an amount of new data to be pushed into a WLAN transmit buffer associated with an LTE logical channel of that i^{th} UE. B_{avail,i} may represent an amount of data available for transmission from UE i for a given LTE logical channel per QoS class.

Given these parameters, the estimated data rate R_{est,i}^{k} for the i^{th} UE and the i^{th} WLAN QoS transmit buffer may be calculated as:

$${R}_{est , i}^{k} ( t ) = {l}^{k} ( t ) * {R}_{max , i} ( t ) , \\ where$$

$${l}^{k} ( t ) = ( 1 - β ) * {l}^{k} ( t - 1 ) + β * {l}_{est}^{k} ( t ) , \\ and$$

$${l}_{est}^{k} ( t ) = \frac{{\sum }_{i}^{ } {B}_{Tx , i}^{k} ( t ) / T}{{\sum }_{i}^{ } {R}_{max , i} ( t )}$$

where lₑₛₜ^{k}(t) is an estimated loading coefficient, Σi B_{Tx,i}^{k}(t) is the amount of data transmitted across all UEs within the time interval T for the k^{th} WLAN QoS transmit buffer, and R_{max,i} is a maximum achievable data rate for the i^{th} UE given current channel conditions and the current modulation and coding scheme. Alternatively, R_{est,i}^{k} may be set to the value of R_{max,i.}

Where a periodic WLAN downlink scheduling timeline is employed, the central LTE-WLAN scheduler module 410-a may perform the following tasks at every T_{sch} interval. Where scheduling instances for LTE and WLAN coincide, the central LTE-WLAN scheduler module 410-a may, for each LTE logical channel (i.e., QoS class) j and the i^{th} UE on the joint priority list, check the type of assignment. If the i^{th} UE and the j^{th} LTE logical channel correspond to a stage 1 LTE assignment, stage 2 LTE actual resource assignment may be performed for that LTE logical channel of that UE.

Otherwise, the i^{th} UE and j^{th} LTE logical channel correspond to a WLAN assignment and the maximum estimated buffer (B_{max,i}^{k}) may be determined for the k^{th} WLAN QoS transmit buffer to which the j^{th} LTE logical channel maps. In order to accurately determine B_{max,i}^{k}, the time within the scheduling window already taken by any previously scheduled UEs may first be updated as follows:

tᵢ₋₁^{k}=B_{WiFi,i-1}^{k}/R_{est,i-1}^{k}

T_{sch}_{_{—}}ₜₐₖₑₙ:=T_{sch}_{_{—}}ₜₐₖₑₙ+tᵢ₋₁^{k}

where T_{sch}_{_{—}}ₜₐₖₑₙ represents the delay due to already queued UEs in the same scheduling instance across all higher priority WLAN QoS transmit buffers and the current k^{th} WLAN QoS transmit buffer. For the very first scheduling in a scheduling instance, T_{sch}_{_{—}}ₜₐₖₑₙ may be set to

T_{sch}_{_{—}}ₜₐₖₑₙ=t₋₁

where t₋₁ is an estimated delay due to the queued data left over from the previous scheduling instance across all UEs. B_{max,i}^{k} may then be determined as

B_{max,i}^{k}−R_{est,i}^{k}*max((T_{sch}*α−T_{sch}_{ₜₐₖₑₙ})0)

where α represents a coefficient used to tune the maximum buffer value. In certain examples, α may take into account loading on the WLAN medium. An α larger than 1 may result in a buffer size overestimate that may be utilized to prevent buffer underflow and compensate for the latencies in the WLAN transmit buffer updates due to ACK latency. If B_{max,i}^{k}=0, the central LTE-WLAN scheduler module 410-a may refrain from placing downlink data from the i^{th} UE and j^{th} LTE logical channel in the k^{th} WLAN QoS transmit buffer, as the k^{th} WLAN QoS transmit buffer may be full.

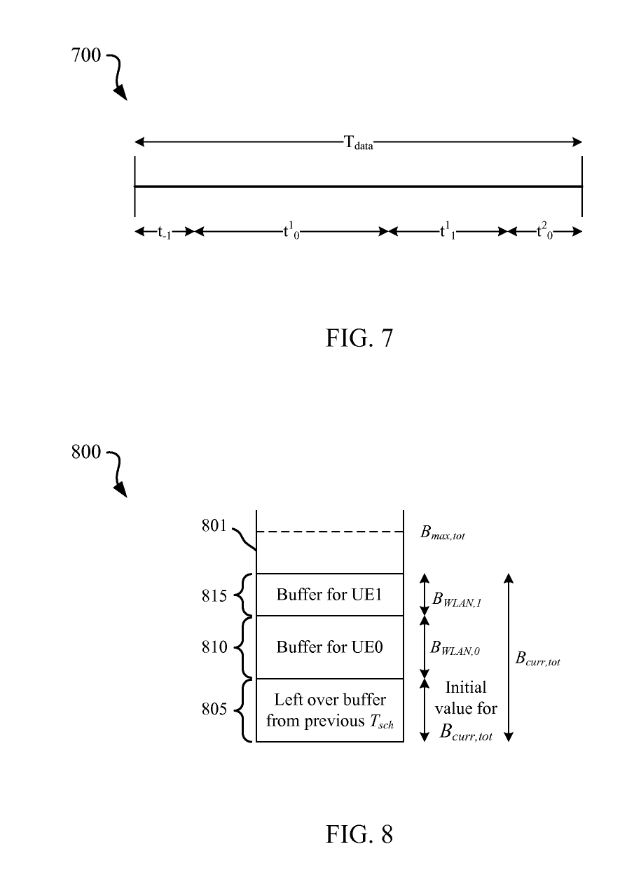

FIG. 7 shows a diagram of a scheduling window 700 during which resources are assigned to WLAN according to the buffer management techniques disclosed herein. As shown in the diagram, the UEs are assigned resources within a time window T_{data} for which the data buffering is provisioned for, where tᵢ^{k} represents an estimated time the i^{th} UE's data put into the k^{th} WLAN QoS buffer would occupy within the T_{data} time window. In the specific example shown in the figure, T_{data} is full from the time t₋₁ occupied by the left over buffer from the previous scheduling window and the time t₀¹ scheduled for the highest priority LTE logical channel of UE 0 mapping to WLAN QoS transmit buffer k=1, the time t₁¹ scheduled for the highest priority LTE logical channel of UE 1 mapping to WLAN QoS transmit buffer k=1, and the time t₀² scheduled for the second highest priority LTE logical channel of UE0 mapping to WLAN QoS transmit buffer k=2. Thus, in the example of FIG. 7, the B_{max,i}^{k} for a next highest priority LTE logical channel would be equal to 0.

Returning to the discussion of FIG. 5, in the event that B_{max,i}^{k} for the k^{th} WLAN QoS transmit buffer is greater than 0, a maximum estimated buffer size of new data from the j^{th} LTE logical channel to push into the k^{th} WLAN QoS transmit buffer may be determined as follows:

B_{WLAN,i}^{k}=min(B_{avail,i}^{j},B_{max,i}^{k})

and B_{WLAN,i}^{k} may be capped based on the maximum total buffer threshold B_{max,tot}^{k} the current size B_{curr,tot}^{k} of the WLAN QoS transmit buffer, and the maximum estimated buffer size B_{WLAN,i}^{k}, as follows:

B_{WLAN,i}^{k}=min(B_{WLAN,i}^{k},B_{max,tot}^{k}−B_{curr,tot}^{k})

The value B_{curr,tot}^{k} may be updated each time data is added to the WLAN QoS transmit buffer. The capped B_{WLAN,i}^{k} may represent the tentative amount of new data to push into the WLAN QoS transmit buffer.

Once B_{WLAN,i}^{k} has been calculated, the central LTE-WLAN scheduler module 410-a may determine a priority between LTE and WLAN for the B_{WLAN,i}^{k} amount of data to UE i over LTE logical channel j. This prioritization may be based on a current state or condition of at least the LTE wireless link and/or WLAN wireless link. If the central LTE-WLAN scheduler module 410-a determines that the data is not to be transmitted over the WLAN wireless link based on the prioritization, the B_{WLAN,i}^{k} amount of data may be scheduled for downlink transmission over LTE, and flow may proceed to the next highest priority UE and LTE logical channel on the priority list.

If the central LTE-WLAN scheduler module 410-a determines that the data is to be transmitted over the WLAN wireless link based on the prioritization, the central LTE-WLAN scheduler module 410-a may begin requesting B_{WLAN,i}^{k} amount of downlink data for the current UE i and LTE logical channel j from the aggregating layer 505, and check if UE i is tentatively scheduled on the LTE priority list at a lower priority (e.g., as UE q, where q is greater than i). If UE i is tentatively scheduled on the LTE priority list at a lower priority, the central LTE-WLAN scheduler module 410-a may update the resource assignments for UEs tentatively scheduled on the LTE list (for every UE r, where r is greater than or equal to q). The B_{WLAN,i}^{k} amount of downlink data for the current UE i and LTE logical channel j received from the RLC layer 505 may then be placed in the WLAN QoS transmit buffer k at the WLAN MAC layer 525. Flow may proceed to the next highest priority UE and LTE logical channel on the priority list.

The use of prioritization between LTE and WLAN may avoid increasing the total packet delay due to the delay of data submitted to the WLAN transmit buffer (i.e., not eligible for transmission on LTE). The prioritization may be beneficial in cases where the amount of data to be transmitted is limited and the estimated delay for the period of time during which the WLAN transmit buffer is filled is larger than the expected delay on LTE to transmit all data available for transmission. In certain examples, the prioritization between the LTE and WLAN may be implemented by first determining, for the i^{th} UE and the current LTE logical channel j (i.e. given QoS class), the parameters d1_{LTE,i} and d2_{LTE,i}, as follows:

$$d {1}_{LTE , i} = \frac{{B}_{tot , i}}{{R}_{LTE , i}}$$

$$d {2}_{LTE , i} = \frac{{B}_{tot , i} - {B}_{WLAN , i}}{{R}_{LTE , i}}$$

where d1_{LTE,i} may be defined as an estimated delay associated with transmitting all available downlink data for the current LTE logical channel j to UE i on LTE without using WLAN, d2_{LTE,i} may be defined as an estimated delay associated with transmitting the total data available for transmission over the current LTE logical channel j to UE i on LTE, as discounted by the potential transmission of B_{WLAN,i} on WLAN, R_{LTE,i} may be defined as an estimated serving data rate to UE i over LTE logical channel j on LTE, B_{tot,i} may be defined as the total data available for transmission (e.g. at the aggregating layer 505) for UE i over the current LTE logical channel j, and B_{WLAN,i} may represent the tentative amount of data to be pushed into the WLAN transmit buffer associated with the current UE i and LTE logical channel j.

In the present example, if d2_{LTE,i}>t_{WLAN,i}, where t_{WLAN,i}=Σⱼ₌₋₁ⁱ tⱼ may represent an expected delay due to already scheduled higher priority UE LTE logical channels, the B_{WLAN,i} bits for the current UE i over LTE logical channel j may be pushed into the WLAN transmit buffer associated with LTE logical channel j of UE i. In the event that d2_{LTE,i}<t_{WLAN,i} and d1_{LTE,i}<t_{WLAN,i}, the B_{WLAN,i} may be set to zero, indicating that none of the bits are to be pushed into the WLAN transmit buffer (i.e. scheduled for WLAN transmission), and instead all of the bits are to be transmitted over LTE. In the event that d2_{LTE,i}<t_{WLAN,i} and d1_{LTE,i}>t_{WLAN,i}, the B_{WLAN,i} bits for the current UE i and the current LTE logical channel j may be pushed (i.e. scheduled for WLAN) into the WLAN transmit buffer associated with UE i and LTE logical channel j.

As discussed above, this process may be repeated for each of the LTE logical channels of each of the UEs, in order of priority. Accordingly, a B_{WLAN} may be determined for each of the LTE logical channels of each of the UEs, in order of priority, until the WLAN QoS transmit buffer in question is full. For each UE and LTE logical channel with a nonzero B_{WLAN} value, the central LTE-WLAN scheduler module 410-a may determine a priority between LTE and WLAN for the B_{WLAN} calculated for that LTE logical channel of that UE.

FIG. 8 illustrates a block diagram of a WLAN QoS transmit buffer 800 following completion of the described iterative process. The WLAN transmit buffer 800 may include data 805 left over from the previous scheduling window, data 810 from an LTE logical channel of UE 0 mapping to that WLAN transmit QoS buffer 800, and data from an LTE logical channel of UE 1 mapping to the WLAN transmit QoS buffer 800. Thus, the current size of the buffer, B_{curr,tot} may be the size of the combination of the data 805, 810, 815. However, as shown in FIG. 8, additional room 801 may be present in the buffer 801 after determining an initial amount of data to push to the WLAN QoS transmit buffer 800 for each UE LTE logical channel associated with that WLAN QoS transmit buffer 800. In certain examples, further steps may be taken to push additional data from the LTE logical channels into the WLAN QoS transmit buffer 800.

For example, returning to the discussion of FIG. 5, if T_{sch}_{_{—}}ₜₐₖₑₙ<T_{sch}*α, the central LTE-WLAN scheduler module 410-a may iterate again through the LTE logical channels of the UEs associated with the WLAN transmit buffer, according to priority, to determine a tentative amount of new data to push into the WLAN transmit buffer for each UE LTE logical channel until T_{sch}_{_{—}}ₜₐₖₑₙ=T_{sch}*α or T_{sch}_{_{—}}ₜₐₖₑₙ approaches T_{sch}*α within a certain threshold. The tentative amount of new data to push to the WLAN transmit buffer for the ith UE and the jₜₕ LTE logical channel may be computed as follows:

B_{max,i}=min(B_{max,i},B_{avail,i},B_{max,tot}^{k}−B_{curr,tot}^{k})

For each tentative amount of new data computed for an LTE logical channel, the previously described process of prioritizing between LTE and WLAN may be employed to determine whether to use LTE or WLAN to transmit the tentative amount of new data computed for that LTE logical channel. In the event that the central LTE-WLAN scheduler module 410-a determines to push the tentative amount of new data to the WLAN transmit buffer, the value of T_{sch}_{_{—}}ₜₐₖₑₙ may be updated, and the central LTE-WLAN scheduler module 410-a may continue iterating through the LTE logical channels of the UEs, according to priority, until T_{sch}_{_{—}}ₜₐₖₑₙ=T_{sch}*α.

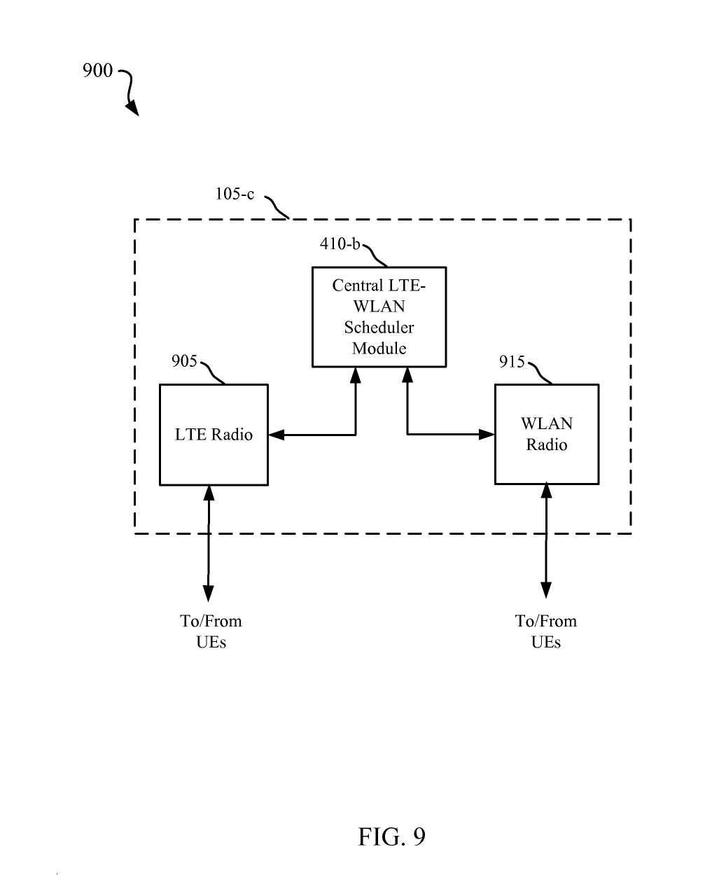

Referring now to FIG. 9, a block diagram 900 of an example LTE-WLAN base station 105-c is shown. The LTE-WLAN base station 105-c may be an example of one or more of the base stations 105 described above with reference to the previous Figures. The LTE-WLAN base station 105-c may include an LTE radio 905, a central LTE-WLAN scheduler module 410-b, and a WLAN radio 915. Each of these components may be in communication, directly or indirectly with one another. Although the discussion of the figure is presented with relation to the LTE and WLAN technologies, other RATs could be used in their place.

In the example shown, the LTE radio 905 may be configured to communicate with multiple UEs over an LTE link(s). The WLAN radio 915 may be configured to communicate with multiple UEs over a WLAN link(s). The central LTE-WLAN scheduler module 410-b may be configured to determine data for downlink transmission and then jointly assign resources for transmitting the downlink data. The joint assignment of resources by the central LTE-WLAN scheduler module 410-b may include prioritizing LTE logical channels associated with the data, generating requests for packets of the DL transmission data and building requested packets at an aggregating layer of the base station based on the jointly assigned resources. The WLAN radio 915 may be further configured to transmit the downlink data to at least a subset of the UEs over the WLAN link during a transmission interval based on the joint assignment of the resources.

In certain examples, each of the UEs may be associated with at least one LTE logical channel, and the central LTE-WLAN scheduler module 410-b may be further configured to determine a priority of each LTE logical channel implemented by each of the UEs and determine an amount of downlink data to add to at least one WLAN transmit buffer for each of the LTE logical channels implemented by each of the UEs in an order defined by the determined priority.

In certain examples, the central LTE-WLAN scheduler module 410-b may be further configured to determine the LTE priority of each LTE logical channel implemented by each of the UEs according to a proportional fairness metric based on a requested LTE data rate, an average served data rate from the aggregating layer, and at least one WLAN delay deadline. The central LTE-WLAN scheduler module 410-b may be further configured to generate a WLAN priority list including an ordering of the LTE logical channels implemented by each of the plurality of UEs according to a WLAN priority assigned to each LTE logical channel. The central LTE-WLAN scheduler module 410-b module may be further configured to determine that a scheduling instance for the WLAN network coincides with a scheduling instance for the LTE network, determine the LTE priority of each LTE logical channel implemented by each of the UEs according to a proportional fairness metric based on a requested LTE data rate, an average served data rate from the aggregating layer, and at least one LTE delay deadline, generate an LTE priority list comprising an ordering of the LTE logical channels implemented by each of the plurality of UEs according to an LTE priority assigned to each LTE logical channel, combine the LTE priority list with the WLAN priority list; and assign downlink data between the LTE links and the WLAN links in an order based on the combination of the LTE priority list with the WLAN priority list.

In certain examples, the central LTE-WLAN scheduler module 410-b may be further configured to determine the maximum estimated buffer size for the WLAN transmit buffer associated with an LTE logical channel based at least in part on a remaining amount of time within a transmission interval and an estimated data transmit rate from the WLAN transmit buffer to the UE implementing the LTE logical channel. The central LTE-WLAN scheduler module 410-b may additionally set an upper bound on the maximum estimated buffer size determined for the WLAN transmit buffer associated with an LTE logical channel based at least in part on a maximum total buffer threshold of the WLAN transmit buffer and the amount of available downlink data for the LTE logical channel at the base station.

In certain examples, each of the LTE logical channels may be associated with a WLAN transmit buffer associated with a quality of service (QoS) class and the central LTE-WLAN scheduler module 410-b may be further configured to determine, according to the order defined by the determined priority, a tentative amount of downlink data from each LTE logical channel to place in the WLAN transmit buffer associated with that LTE logical channel. The tentative amount of data may be based at least in part on a maximum estimated buffer size for the WLAN transmit buffer associated with that LTE logical channel and an amount of available downlink data for that LTE logical channel.

In certain examples, the central LTE-WLAN scheduler module 410-b may be further configured to determine, in response to the tentative amount for one of the LTE logical channels being greater than zero, whether to add the tentative amount of the downlink data from that LTE logical channel to the WLAN transmit buffer associated with that LTE logical channel based on a prioritization between the one or more of the LTE link and the WLAN link for that LTE logical channel and the UE implementing that LTE logical channel during the transmission interval.

The central LTE-WLAN scheduler module 410-b may be configured to determine the prioritization between the WLAN network and the LTE network for that LTE logical channel during the scheduling window (i.e. transmission interval) based on a difference in a total estimated delay of transmitting a total amount of available data for the WLAN transmit buffer associated with that LTE logical channel over the LTE network and a total estimated delay of transmitting the total amount of available data for the WLAN transmit buffer associated with that LTE logical channel according to the determined tentative amount.

In certain examples, the central LTE-WLAN scheduler module 410-b may be further configured to determine, in response to a determination to add the tentative amount of downlink data to the WLAN transmit buffer associated with that LTE logical channel, whether downlink LTE resources are currently scheduled for the UE implementing that LTE logical channel during the transmission interval, and update tentative UE downlink resource assignments based on the determination that downlink LTE resources are currently scheduled for the UE.

In certain examples, the central LTE-WLAN scheduler module 410-b may be further configured to build, for each of the LTE logical channels implemented by at least the subset of the UEs, at least one packet at the aggregating layer comprising the determined amount of downlink data to add to the at least one WLAN transmit buffer associated with that LTE logical channel.

In certain examples, the central LTE-WLAN scheduler module 410-b may be further configured to add, for each of the LTE logical channels implemented by at least the subset of the UEs, the determined amount of downlink data to the at least one WLAN transmit buffer associated with that LTE logical channel.

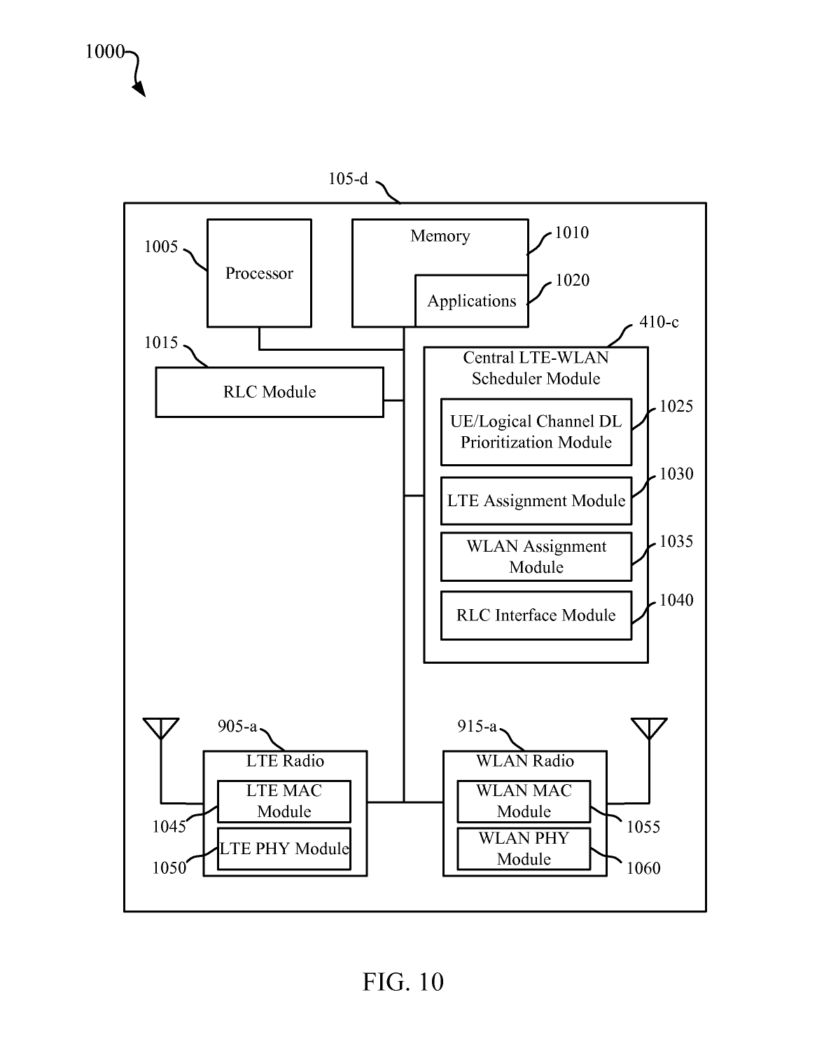

Referring now to FIG. 10, a block diagram 1000 of another example LTE-WLAN base station 105-d is shown. The LTE-WLAN base station 105-d may be an example of one or more of the base stations 105 described above with reference to the previous Figures. The LTE-WLAN base station 105-d may include at least one processor 1005, memory 1010, an RLC module 1015, a central LTE-WLAN scheduler module 410-c, an LTE radio 905-a, and a WLAN radio 915-a. Each of these components may be in communication, directly or indirectly with one another. In certain examples, the processor 1005 may be configured to execute computer-readable program code stored on the memory 1010 to execute one or more of the functions associated with the RLC module 1015, the central LTE-WLAN scheduler module 410-c, the LTE radio 905-a, and/or the WLAN radio 915-a. Additionally or alternatively, one or more functions associated with these components may be implemented by ASICs or other special- or general-purpose hardware arranged and interconnected to perform the functionality associated with each component.

The LTE radio 905-a may include an LTE MAC module 1045 and an LTE PHY module 1050 configured to implement the MAC and PHY network layers of an LTE wireless link. Likewise, the WLAN radio 915-a may include a WLAN MAC module 1055 and a WLAN PHY module 1060 configured to implement the respective MAC and PHY network layers of a WLAN wireless link. The RLC module 1015 may implement a single RLC layer that feeds packets from applications 1020 and higher network layers to both the LTE radio 905-a and the WLAN radio 915-a for downlink transmission to a number of UEs. The LTE MAC layer implemented by the LTE MAC module 1045 may prepare the received packets for downlink transmission by the LTE PHY module 1050 on the LTE PHY layer. The central LTE-WLAN scheduler module 410-c may selectively request packets from the RLC layer implemented by the RLC module 1015 for distribution to the LTE radio 905-a and the WLAN radio 915-a.

The central LTE-WLAN scheduler module 410-c may perform the functionality described above with reference one or more of the central LTE-WLAN scheduler modules 410 of the previous Figures. In the present example, the central LTE-WLAN scheduler module 410-c may include a UE/logical channel downlink prioritization module 1025 configured to arrange LTE logical channels of individual UEs into priority lists for resource assignment, an LTE assignment module 1030 configured to perform stage 1 and stage 2 LTE resource assignment based on the priority lists, a WLAN assignment module 1035 configured to push downlink data into one or more WLAN QoS transmit buffers of the WLAN radio 915-a based on the priority lists and a prioritization between LTE and WLAN according to the states of the respective WLAN and LTE wireless links for a given UE, and an RLC interface module 1040 configured to request RLC packets from the RLC module 1015 and selectively direct the RLC packets to the LTE radio 905-a or the WLAN radio 915-a.

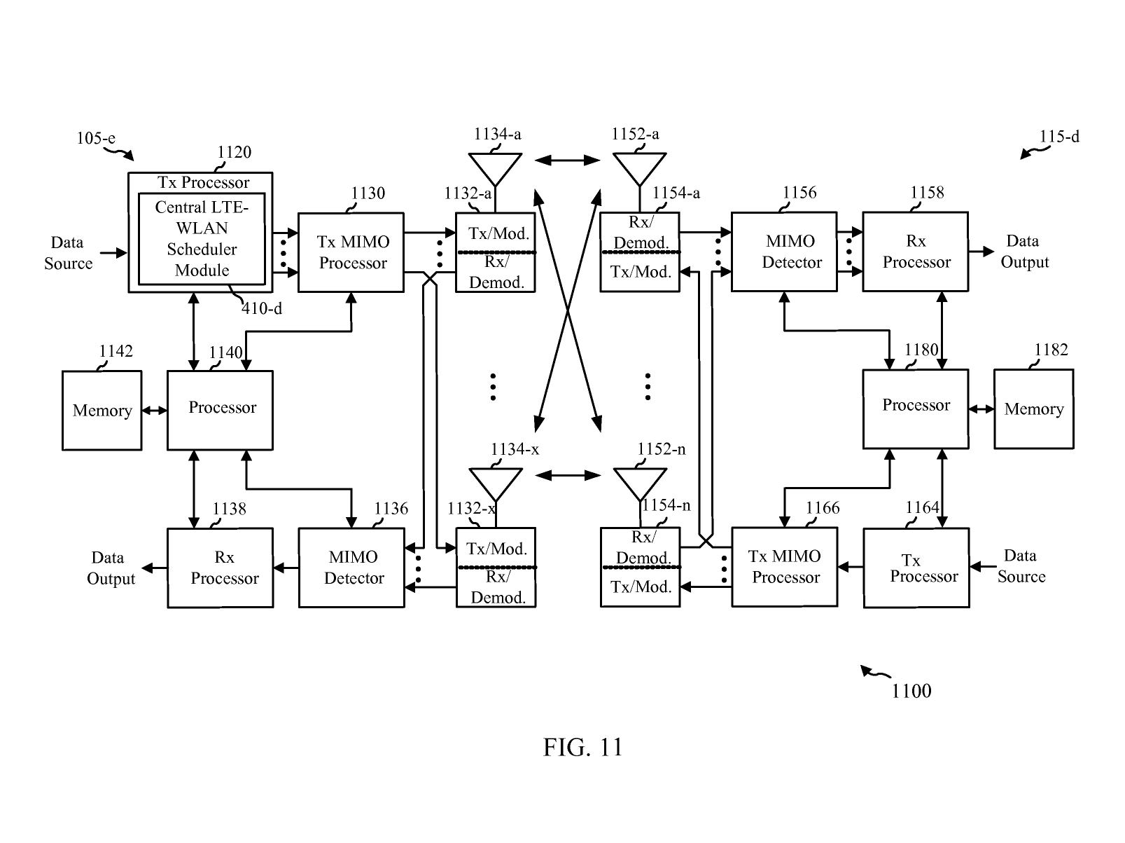

FIG. 11 is a block diagram of a MIMO communication system 1100 including an LTE-WLAN base station 105-e and a UE 115-d. This system 1100 may illustrate aspects of the systems and networks 100, 200, 400 of FIG. 1, 2, or 4. The LTE-WLAN base station 105-e may be equipped with antennas 1134-a through 1134-x, and the UE 115-d may be equipped with antennas 1152-a through 1152-n. In the system 1100, the LTE-WLAN base station 105-e may be able to send data over multiple communication links at the same time. Each communication link may be called a “layer” and the “rank” of the communication link may indicate the number of layers used for communication. For example, in a 2×2 MIMO system where LTE-WLAN base station 105-e transmits two “layers,” the rank of the communication link between the LTE-WLAN base station 105-e and the UE 115-d is two.

At the LTE-WLAN base station 105-e, a transmit processor 1120 may receive data from a data source. The transmit processor 1120 may process the data. The transmit processor 1120 may also generate reference symbols, and a cell-specific reference signal. A transmit (TX) MIMO processor 1130 may perform spatial processing (e.g., precoding) on data symbols, control symbols, and/or reference symbols, if applicable, and may provide output symbol streams to the transmit modulators 1132-a through 1132-x. Each modulator 1132 may process a respective output symbol stream (e.g., for OFDM, etc.) to obtain an output sample stream. Each modulator 1132 may further process (e.g., convert to analog, amplify, filter, and upconvert) the output sample stream to obtain a downlink (DL) signal. In one example, DL signals from modulators 1132-a through 1132-x may be transmitted via the antennas 1134-a through 1134-x, respectively.

Consistent with the foregoing principles, the transmit processor 1120 may include a central LTE-WLAN scheduler module 410-d configured to add downlink data from an aggregating layer of the LTE-WLAN base station 105-e to at least one WLAN transmit buffer based on the joint assignment of resources. The downlink data may be transmitted over a WLAN radio during a scheduling window over modulators 1154 during the scheduling window according to the joint assignment of resources.

At the UE 115-d, the UE antennas 1152-a through 1152-n may receive the DL signals from the LTE-WLAN base station 105-e and may provide the received signals to the demodulators 1154-a through 1154-n, respectively. Each demodulator 1154 may condition (e.g., filter, amplify, downconvert, and digitize) a respective received signal to obtain input samples. Each demodulator 1154 may further process the input samples (e.g., for OFDM, etc.) to obtain received symbols. A MIMO detector 1156 may obtain received symbols from all the demodulators 1154-a through 1154-n, perform MIMO detection on the received symbols if applicable, and provide detected symbols. A receive processor 1158 may process (e.g., demodulate, deinterleave, and decode) the detected symbols, providing decoded data for the UE 115-d to a data output, and provide decoded control information to a processor 1180, and/or memory 1182.

On the uplink (UL), at the UE 115-d, a transmit processor 1164 may receive and process data from a data source. The transmit processor 1164 may also generate reference symbols for a reference signal. The symbols from the transmit processor 1164 may be precoded by a transmit MIMO processor 1166 if applicable, further processed by the modulators 1154-a through 1154-n (e.g., for SC-FDMA, etc.), and be transmitted to the LTE-WLAN base station 105-a-4 in accordance with the transmission parameters received from the LTE-WLAN base station 105-a-4.

At the LTE-WLAN base station 105-e, the UL signals from the UE 115-d may be received by the antennas 1134, processed by the demodulators 1132, detected by a MIMO detector 1136 if applicable, and further processed by a receive processor. The receive processor 1138 may provide decoded data to a data output and to the processor 1140 and/or memory 1142. The components of UE 115-d may, individually or collectively, be implemented with one or more Application Specific Integrated Circuits (ASICs) adapted to perform some or all of the applicable functions in hardware. Each of the noted modules may be a means for performing one or more functions related to operation of the system 1100. Similarly, the components of the LTE-WLAN base station 105-a-4 may, individually or collectively, be implemented with one or more Application Specific Integrated Circuits (ASICs) adapted to perform some or all of the applicable functions in hardware. Each of the noted components may be a means for performing one or more functions related to operation of the system 1100.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. At the Physical layer, the transport channels may be mapped to Physical channels.

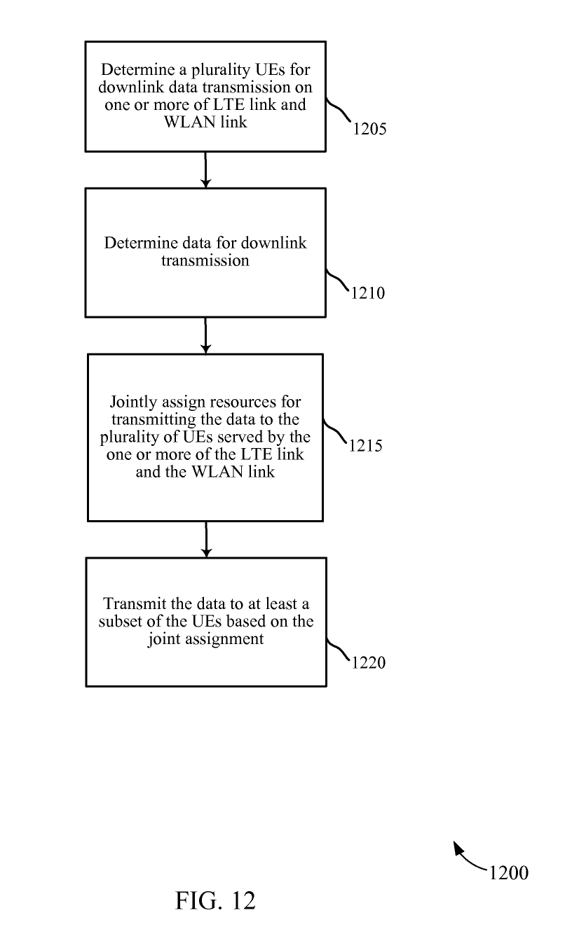

FIG. 12 is a flow chart of an illustrative method 1200 of managing downlink transmissions of a base station in a wireless communications system. The method 1200 may be performed, for example, by one or more of the base stations 105 described above with reference to the previous Figures.

At block 1205, the base station may determine a plurality of UEs for downlink data transmission on one or more of an LTE link and a WLAN link A first radio may be used for transmitting data on one or more of the LTE links and a second radio may be used for transmitting data over the one or more of the WLAN links. Data for downlink transmissions on the one or more LTE and WLAN links may be aggregated at a common layer of the base station. At block 1210, the base station may determine data for the downlink transmission. At block 1215, the base station may jointly assign resources for transmitting the data to the plurality of the UEs served by the one or more of the LTE link and the WLAN link. The joint assignment of resources may include prioritizing LTE logical channels associated with the data determined for downlink transmission and building packets from the data at the aggregating layer of the base station in response to a received request for packets of the DL transmission data. At block 1220, the base station may transmit the data to at least a subset of the UEs based on the joint assignment of resources.

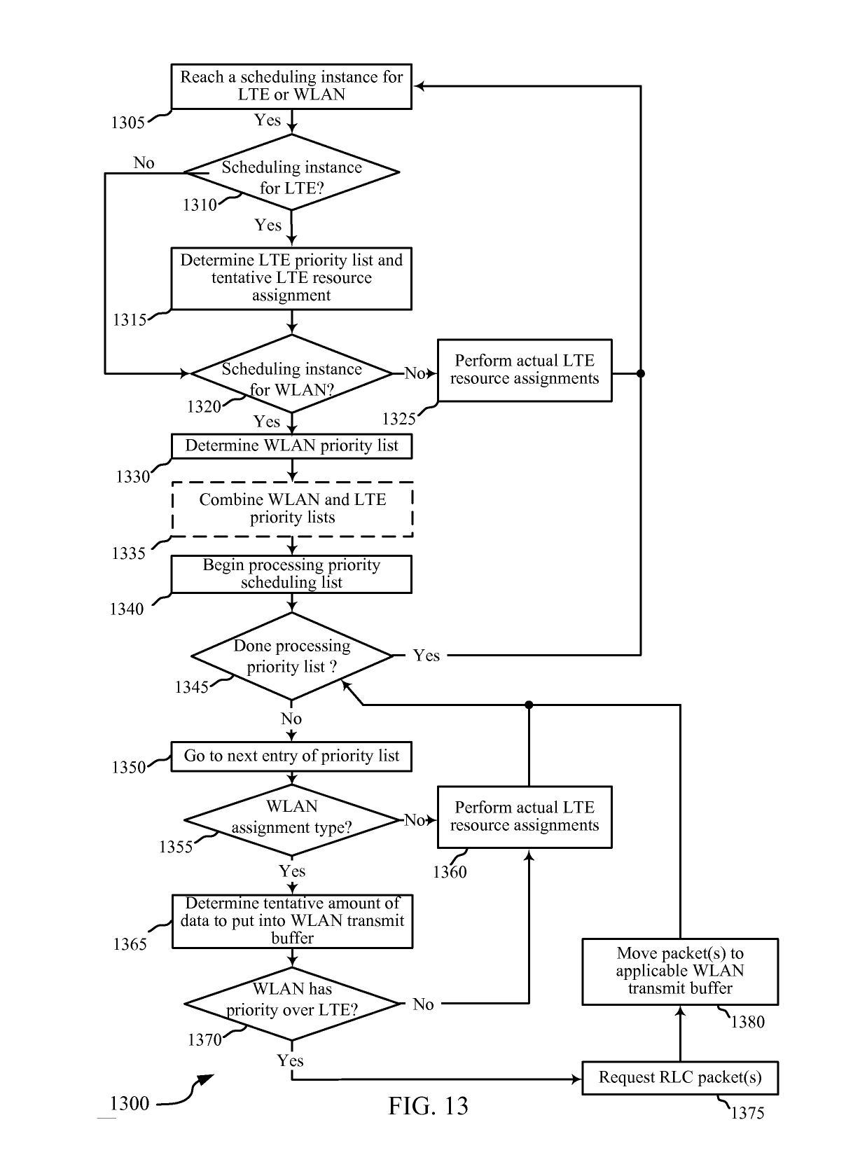

FIG. 13 is a flow chart of another illustrative method 1300 of managing downlink transmissions of a base station in a wireless communications system. The method 1300 may be performed, for example, by one or more of the base stations 105 described above with reference to the previous Figures. The method 1300 may be an example of a process for jointly assigning resources by the base station for transmitting downlink data to multiple UEs from an aggregating layer of the base station according to block 1215 of FIG. 12.

At block 1305, a scheduling instance for LTE or WLAN downlink scheduling may be reached. The scheduling instance for LTE downlink scheduling may occur periodically (e.g., every lms). The WLAN downlink scheduling may be periodic, threshold or event-based, or a combination of periodic and threshold or event-based, as discussed above. At block 1310, the base station may determine whether the current scheduling instance is a scheduling instance for LTE. In the event that the current scheduling instance is an LTE scheduling instance (block 1310, Yes), the base station may determine an LTE priority list and tentative (stage 1) LTE resource assignments for downlink data to multiple UEs (block 1315). The LTE priority list may be based on an LTE-specific proportional fairness computation, as described above. At block 1320, a determination may be made as to whether the current scheduling instance is also a scheduling instance for WLAN. If not (block 1320, No), the base station may perform actual (stage 2) LTE resource assignments for the downlink data to the multiple UEs (block 1325), and flow may return to block 1305.

If the current scheduling instance is a scheduling instance for WLAN (block 1310, No, or block 1320, Yes), at block 1330 a WLAN priority list of LTE logical channels for the multiple UEs may be determined. The WLAN priority list may be based on a WLAN-specific proportional fairness computation, as described above. In examples where the current scheduling instance is for WLAN only, the priority scheduling list may be the WLAN priority list created at block 1330. In examples where the current WLAN scheduling instance coincides with an LTE scheduling instance, the priority scheduling list may be the combined WLAN and LTE priority list created at block 1335. At block 1340, the base station may begin processing the priority scheduling list. At block 1345, a determination may be made as to whether resource assignment for all of the LTE logical channels of the UEs on the priority list is complete, that is, whether the base station is done processing the priority list. If so (block 1345, Yes), flow may return to block 1305.

Otherwise (block 1345, No), a next entry on the priority list may be selected at block 1350, and a determination may be made at block 1355 whether the priority list entry corresponds to a WLAN assignment type. As discussed above, each entry of the priority list may be associated with a unique pair of a UE and LTE logical channel. In certain examples, the priority list entries may be ordered primarily by LTE logical channel, and secondarily by UE. If the current entry is not a WLAN assignment type (block 1355, No), actual (i.e., stage 2) LTE resource assignments may be performed for the UE and LTE logical channel of the current priority list entry, and flow may return to block 1345. Otherwise (block 1355, Yes), a tentative amount of data to put into the WLAN transmit buffer may be determined at block 1365, and a determination may be made as to whether WLAN has priority over LTE for the UE and LTE logical channel of the current priority list entry.

If LTE has priority (block 1370, No), actual LTE resource assignments may be performed at block 1360, and flow may return to block 1345. If WLAN has priority over LTE (block 1370, Yes), one or more RLC packets may be requested for the determined tentative amount of data at block 1375, and the packet(s) may be moved to the applicable WLAN transmit buffer for the LTE logical channel and UE of the current priority list entry at block 1380. Flow may then return to block 1345.

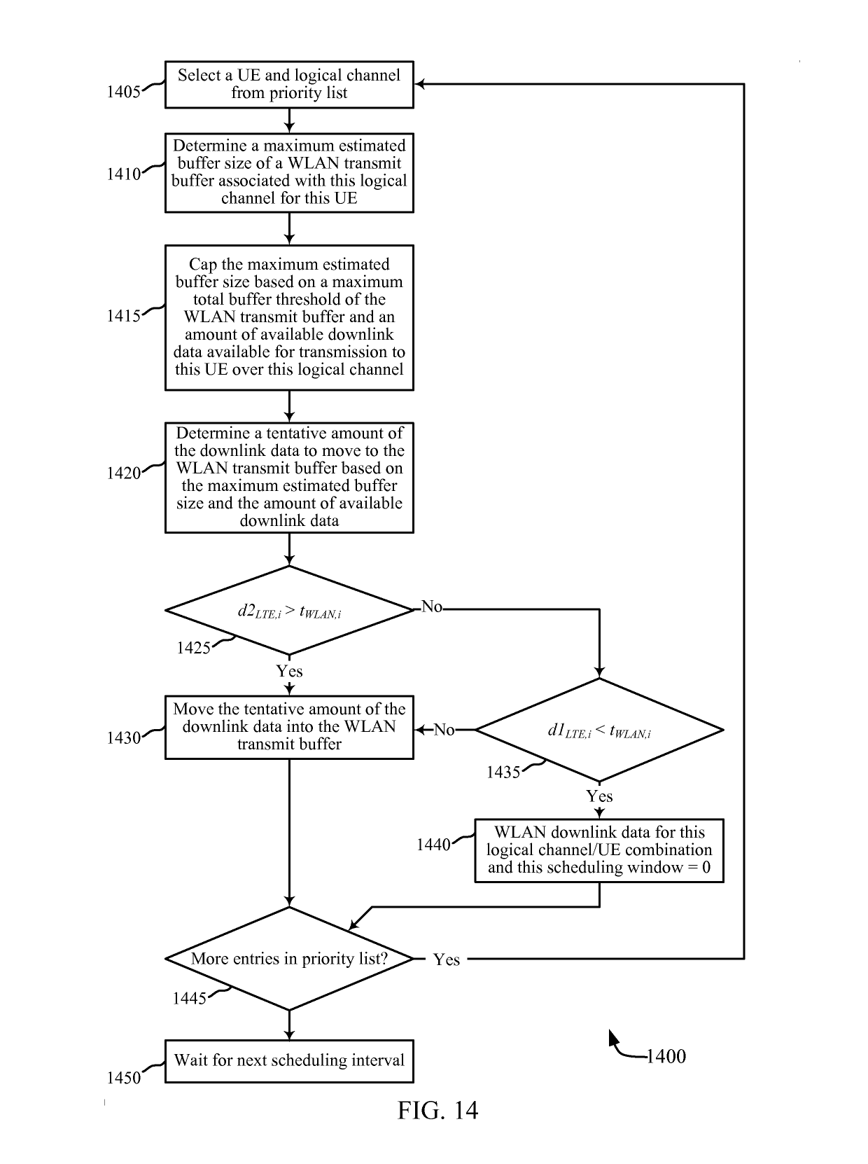

FIG. 14 is a flow chart of another illustrative method 1400 of managing downlink transmissions of a base station in a wireless communication system. The method 1400 may be performed, for example, by one or more of the base stations 105 described above with reference to the previous Figures. The method 1400 may be an example of a process for determining a tentative amount of data to put into a WLAN transmit buffer for a given LTE logical channel of a UE and determining whether WLAN has priority over LTE for the given LTE logical channel of the UE, according to blocks 1360, 1355, 1370, and 1375 of FIG. 13.

At block 1405, a current UE (i) and LTE logical channel (j) may be selected. The current LTE logical channel (j) may map to one or more specific WLAN transmit buffers (k). At block 1410, a maximum estimated buffer size for the current LTE logical channel (e.g., may be determined. At block 1415, the maximum estimated buffer size may be capped based on based an amount of data available for transmission to UE i over LTE logical channel j and a maximum total buffer threshold of the WLAN transmit buffer.

At block 1420, a tentative amount of downlink data (e.g., B_{WLAN,i}) to push into the WLAN transmit buffer k for the LTE logical channel j of UE i may be determined. At block 1425, a determination may be made as to whether an estimated delay (d2_{LTE,i}) on LTE for the total available data for transmission, as discounted by the potential transmission of the tentative amount over the WLAN wireless link, is greater than an expected delay (t_{WLAN,i}) due to downlink data already scheduled for WLAN transmission for higher priority LTE logical channels. If so (block 1425, Yes), the tentative amount of the downlink data (e.g., B_{WLAN,i}) may be moved into the WLAN transmit buffer k at block 1430. Otherwise (block 1425, No), a determination may be made as to whether an estimated delay on LTE (d1_{LTE,i}) for the total data available for transmission from the current LTE logical channel, without using WLAN, is less than the expected delay (t_{Wifi,i}) due to downlink data already scheduled for WLAN transmission for higher priority UE LTE logical channels. If d1_{LTE,i} is greater than t_{WLAN,i} (block 1435, No), the tentative amount of the downlink data (e.g., B_{WLAN,i}) may be moved into the WLAN transmit buffer k at block 1430. Otherwise (block 1435, Yes), no downlink data may be scheduled for transmission over the WLAN wireless link for this LTE logical channel and UE combination during this scheduling window, according to block 1440.

At block 1445, a determination may be made as to whether additional LTE logical channel jUE entries remain for analysis in a priority list. If additional entries remain (block 1445, Yes), flow may return to block 1405, where a next highest priority LTE logical channel of a UE may be selected. Otherwise, flow may proceed to block 1450, at which the base station may await a next scheduling interval.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein, but is to be accorded the widest scope consistent with the principles and novel features disclosed herein.

What is claimed is:

1. A method of wireless communication, comprising:
determining, by a base station, a plurality of user equipments (UEs) for downlink data transmission on one or more of a Long-Term Evolution (LTE) link and a wireless local area network (WLAN) link in a first transmission interval;
determining data for the downlink (DL) transmission;
jointly assigning resources for transmitting the data in the first transmission interval when the UEs are served on the one or more of the LTE link and the WLAN link, including:
prioritizing portions of the data for the DL transmission on the respective LTE and WLAN links on a per-link basis;
requesting packets for the DL transmission based on the jointly assigned resources, wherein the packets are requested from an aggregating layer of the base station for the LTE link and the WLAN link; and;
transmitting packets received from the aggregating layer to at least a subset of the UEs during the first transmission interval.

2. The method of claim 1, wherein jointly assigning resources on the WLAN link is based at least in part on a fill level of one or more WLAN transmit buffers prior to the first transmission interval.

3. The method of claim 1, wherein jointly assigning resources is based at least in part on a channel quality of the WLAN link.

4. The method of claim 3, further comprising:
determining channel quality of the WLAN link according to a WLAN interface data rate or a WLAN interface error rate.

5. The method of claim 1, wherein jointly assigning resources is based at least in part on a transmission delay associated with the WLAN link and a transmission delay associated with the LTE link.

6. The method of claim 1, wherein each of the plurality of UEs is associated with at least one LTE logical channel, the method further comprising:
determining a priority of each LTE logical channel implemented by each of the plurality of UEs; and
determining an amount of downlink data to add to one or more WLAN transmit buffers for each of the LTE logical channels implemented by each of the UEs in an order defined by the determined priority.

7. The method of claim 1, wherein the transmitting comprises adding the packets to one or more WLAN transmit buffers associated with different Quality of Service (QoS) levels.

8. The method of claim 6, further comprising:
determining a WLAN priority for each LTE logical channel implemented by each of the plurality of UEs; and
generating a WLAN priority list comprising an ordering of the LTE logical channels implemented by each of the plurality of UEs based on the determined WLAN priority for each LTE logical channel.

9. The method of claim 8, further comprising:
determining that a scheduling instance for the WLAN link coincides with a scheduling instance for the LTE link;
determining an LTE priority for each LTE logical channel implemented by each of the plurality of UEs;
generating an LTE priority list comprising an ordering of the LTE logical channels implemented by each of the plurality of UEs based on the LTE priority determined for each LTE logical channel;
combining the LTE priority list with the WLAN priority list; and
assigning the data for DL transmission between the one or more of the LTE link and the WLAN link in an order based on the combination of the LTE priority list with the WLAN priority list.

10. The method of claim 6, further comprising:
determining, according to the order defined by the determined priority, a tentative amount of downlink data from each LTE logical channel to place in the one or more WLAN transmit buffers associated with that LTE logical channel, wherein the tentative amount of downlink data is based at least in part on a maximum estimated buffer size for the one or more WLAN transmit buffers associated with that LTE logical channel and an amount of available downlink data for that LTE logical channel.

11. The method of claim 10, further comprising:
determining the maximum estimated buffer size for the one or more WLAN transmit buffers associated with that LTE logical channel based at least in part on a remaining amount of time within the first transmission interval and an estimated data transmit rate from the one or more WLAN transmit buffers to the UE implementing the LTE logical channel.

12. The method of claim 10, further comprising:
determining whether to add the tentative amount of downlink data from that LTE logical channel to the one or more WLAN transmit buffers associated with that LTE logical channel based on a prioritization between the one or more of the LTE link and the WLAN link for that LTE logical channel and the UE implementing that LTE logical channel during the first transmission interval.

13. The method of claim 12, further comprising:
determining the prioritization between the WLAN link and the LTE link for that LTE logical channel during the first transmission interval based on a difference in a total estimated delay of transmitting a total amount of available data for the one or more WLAN transmit buffers associated with that LTE logical channel over the LTE link and a total estimated delay of transmitting the total amount of available data for the one or more WLAN transmit buffers associated with that LTE logical channel according to the determined tentative amount.

14. The method of claim 12, further comprising:
determining, in response to a determination to add the tentative amount of downlink data to the one or more WLAN transmit buffers associated with that LTE logical channel, whether downlink LTE resources are currently scheduled for the UE implementing that LTE logical channel during the first transmission interval; and
updating tentative UE downlink resource assignments based on the determination that downlink LTE resources are currently scheduled for the UE.

15. The method of claim 6, further comprising:
adding the determined amount of the downlink data to the one or more of the WLAN transmit buffers for each of the LTE logical channels implemented by each of the UEs;
determining that an estimated amount of resources associated with a current amount of data in the one or more of the WLAN transmit buffers is less than a threshold following the adding of the determined amount of the downlink data to the one or more of the WLAN transmit buffers; and
determining a new amount of downlink data to add to the one or more of the WLAN transmit buffers for each of the LTE logical channels implemented by each of the UEs in an order defined by the determined priority.

16. A base station, comprising:
a first radio configured to communicate over a Long-Term Evolution (LTE) link;
a second radio configured to communicate over a wireless local area network (WLAN) link; and
at least one processor comprising a scheduler module operative to control the first radio and the second radio, the scheduler module configured to:
determine data for a downlink (DL) transmission;
jointly assign resources for transmitting the data in a first transmission interval when a plurality of user equipments (UEs) are served by the base station on the LTE link and the WLAN link, including:
prioritize portions of the data for the DL transmission on the respective LTE and WLAN links on a per-link basis,
request packets for the DL transmission based on the jointly assigned resources, wherein the packets are generated at an aggregating layer of the base station for transmission on the LTE link and the WLAN link,
send the packets generated by the aggregating layer to the first radio and the second radio for transmission on the LTE link and the WLAN link respectively; and
a memory coupled to the at least one processor.

17. The base station of claim 16, wherein jointly assigning resources on the WLAN link is based at least in part on a fill level of one or more WLAN transmit buffers prior to the first transmission interval.

18. The base station of claim 16, wherein jointly assigning resources is based at least in part on a channel quality of the WLAN link.

19. The base station of claim 16, wherein each of the UEs is associated with at least one LTE logical channel and the scheduler module is further configured to:
determine a priority of each LTE logical channel implemented by each of the plurality of UEs; and
determine an amount of downlink data to add to one or more WLAN transmit buffers for each of the LTE logical channels implemented by each of the UEs in an order defined by the determined priority.

20. The base station of claim 16, wherein the sending comprises adding the packets to one or more WLAN transmit buffers associated with different Quality of Service (QoS) levels.

21. The base station of claim 19, wherein the scheduler module is further configured to:
determine a WLAN priority for each LTE logical channel implemented by each of the plurality of UEs; and
generate a WLAN priority list comprising an ordering of the LTE logical channels implemented by each of the plurality of UEs based on the determined WLAN priority for each LTE logical channel.

22. The base station of claim 21, wherein the scheduler module is further configured to:
determine that a scheduling instance for the WLAN link coincides with a scheduling instance for the LTE link;
determine an LTE priority for each LTE logical channel implemented by each of the plurality of UEs;
generate an LTE priority list comprising an ordering of the LTE logical channels implemented by each of the plurality of UEs according to the LTE priority assigned to each LTE logical channel;
combine the LTE priority list with the WLAN priority list; and
assign the data for DL transmission between the one or more of LTE link and the WLAN link in an order based on the combination of the LTE priority list with the WLAN priority list.

23. The base station of claim 19, wherein the scheduler module is further configured to:
determine, according to the order defined by the determined priority, a tentative amount of downlink data from each LTE logical channel to place in the one or more WLAN transmit buffers associated with that LTE logical channel, wherein the tentative amount of downlink data is based at least in part on a maximum estimated buffer size for the one or more WLAN transmit buffers associated with that LTE logical channel and an amount of available downlink data for that LTE logical channel.

24. The base station of claim 23, wherein the scheduler module is further configured to:
determine whether to add the tentative amount of downlink data from that LTE logical channel to the one or more WLAN transmit buffers associated with that LTE logical channel based on a prioritization between the LTE link and the WLAN link for that LTE logical channel and the UE implementing that LTE logical channel during the first transmission interval.

25. The base station of claim 24, wherein the scheduler module is further configured to:
determine the prioritization between the WLAN link and the LTE link for that LTE logical channel during the first transmission interval based on a difference in a total estimated delay of transmitting a total amount of available data for the one or more WLAN transmit buffers associated with that LTE logical channel over the LTE link and a total estimated delay of transmitting the total amount of available data for the one or more WLAN transmit buffers associated with that LTE logical channel over on one or more of the LTE link and the WLAN link according to the determined tentative amount.

26. The base station of claim 24, wherein the scheduler module is further configured to:
determine, in response to a determination to add the tentative amount of downlink data to the one or more WLAN transmit buffers associated with that LTE logical channel, whether DL LTE resources are currently scheduled for the UE implementing that LTE logical channel during the first transmission interval; and
update tentative UE downlink resource assignments based on the determination that downlink LTE resources are currently scheduled for the UE.

27. A base station apparatus for managing downlink transmissions, comprising:
means for determining, by a base station, a plurality of user equipments (UEs) for downlink data transmission on one or more of a Long-Term Evolution (LTE) link and a wireless local area network (WLAN) link in a first transmission interval;
means for determining data for the downlink (DL) transmission;
means for jointly assigning resources for transmitting the data in the first transmission interval when the UEs are served on the one or more of the LTE link and the WLAN link, including:
means for prioritizing portions of the data for the DL transmission on the respective LTE and the WLAN links on a per-link basis;
means for requesting packets for the DL transmission based on the jointly assigned resources, wherein the packets are requested from an aggregating layer of the base station for the LTE and the WLAN links; and
means for transmitting packets from the aggregating layer to at least a subset of the UEs during the first transmission interval.

28. The base station apparatus of claim 27, wherein jointly assigning resources on the WLAN link is based at least in part on a fill level of one or more WLAN transmit buffers prior to the first transmission interval.

29. The base station apparatus of claim 28, wherein the means for transmitting is configured to add the packets to one or more WLAN transmit buffers associated with different Quality of Service (QoS) levels.

30. A computer program product, comprising:
a non-transitory computer readable medium comprising computer-readable program code stored thereon, the computer-readable program code comprising:
computer-readable program code configured to cause at least one processor to determine a plurality of user equipments (UEs) for downlink data transmission on one or more of a Long-Term Evolution (LTE) link and a wireless local area network (WLAN) link in a first transmission interval;
computer-readable program code configured to cause the at least one processor to determine data for the downlink (DL) transmission;
computer-readable program code configured to jointly assigning resources for transmitting the data in the first transmission interval when the UEs are served on the one or more of the LTE link and the WLAN link, including:
computer-readable program code configured to prioritize portions of the data for the DL transmission on the respective LTE and the WLAN links on a per-link basis;
computer-readable program code configured to receive a request for packets for the DL transmission based on the jointly assigned resources, wherein the packets are requested from an aggregating layer of a base station for the LTE and the WLAN links; and
computer-readable program code configured to cause the at least one processor to transmit packets received from the aggregating layer to at least a subset of the UEs during the first transmission interval.
